(19) United States
(12) Patent Application Publication
(10) Pub. No.: US 2011/0097693 A1
(43) Pub. Date: Apr. 28, 2011

(54) Aligning chunk translations for language learners

(76) Inventor: Richard Henry Dana Crawford, Denver, CO (US)

(21) Appl. No.: 12/925,732

(22) Filed: Oct. 28, 2010

Related U.S. Application Data
(60) Provisional application No. 61/279,925, filed on Oct. 28, 2009.

(51) Int. Cl. G09B 19/06

(52) U.S. Cl. 434/157

(57) ABSTRACT

A method and apparatus to align and edit chunks of text and translation. Language learners compare segments of text and translation. Both text and translation are segmented into word groups or “chunks” and related to each other. The related chunks are aligned to facilitate their comparison. For a reader, unfamiliar chunks can be related to more familiar chunks. Constant alignment of text and translation chunks occurs in many variable outputs, including bifocal formats and directly editable alignments. Thus, human edits and improvements input into the system can inform improving machine chunk translation. Both text and translation are editable within one single document, manageable in a wide variety of text editing environments, including common Textarea Input fields. Resulting chunk translations are easily printed on paper and/or displayed electronically. Language learners using the system may include humans and machines. Productions of aligned texts are customized for individual language learners.

### CROSS REFERENCE TO RELATED APPLICATION

This application relates to U.S. Application No. 61/279,925, filed Oct. 28, 2009, entitled “Aligning Chunk Translations for Language Learners”, by the same inventor, which is incorporated herein by reference.

### FIELD OF THE INVENTION

The present invention relates to education; particularly relating to tools and techniques to learn language.

### BACKGROUND OF THE INVENTION

Global communications make people want to learn language. The Internet enables people around the world to communicate as never before was possible in the course of human history. More and more, people from different cultures can now talk to each other, make friends, negotiate agreements, and work together to advance the Arts and Sciences.

Worldwide, the demand to learn language is growing. Today, well over a billion people are learning English as a second language. English is the de facto lingua franca of the Internet. Three billion are likely to be learning English in 2015. Billions of us want to learn more language. Thousands of language methods are available. Which methods are effective? How do they work?

How do we learn language? According to Dr. Stephen Krashen, one key is called “Comprehensible Input”. As a language learner hears, reads and understands words used repeatedly in various contexts, associations are made between the words and their commonly understood meanings. How can we experience words repeatedly used in multiple contexts? The fastest way to experience words and phrases repeating repeatedly in variable contexts is through the practice of reading.

Reading is key. While it's not the only way to learn language, reading is one of the most powerful language instruction techniques known to exist: Dr. Krashen lauds “FVR” or Free Voluntary Reading as one of the most productive possible practices for language learning. In FVR, the learner is encouraged to, read any text that can be generally understand and, importantly, is wanted and liked. Starting with very simple texts, the student gets to know some basic words, then uses these known words as a foundation to “scaffold” up to a few new words; a few new words are introduced and used in contexts with many words that are already known.

New words are learned when used in context with known words. We use words we know to learn new words. Dr. Krashen's “i+1” or “scaffolding” theory suggests that many new words are learned as they are used in context with words that are already known. The ideal text, according to his research, includes around 5% of new words that are unknown to the student. Knowledge of 95% of the surrounding words and the context created by them typically enable a student to decipher the meaning of the new words.

New words are learned when they are cared about. Most language users don't care about or even know, explicitly, the rules of grammar, even in their native language. It's like how people use cars or computers: people don't really care how they work; people just want to use them to go places and to get things done. Dr. Krashen says learning language is largely an unconscious process that occurs especially when we understand and relate to the meaningful messages that words in a language can convey. We care less about the words, and more about what they say.

New words are learned when they are believed. People don't really care about language learning methods. People do care about messages that are truthful; messages that can be believed. Authentic texts from any language culture can help people learn the language. They are real. They are not artificially constructed to help anyone learn any language. Instead, they use language to say things that real people actually care about. Thus, songs, movies, comedies, tragedies, jokes, sayings, conversations, interviews and other such expressions in authentic text can be used as real, trustworthy and believable materials.

A few words can say many things. Statistically, fully half of the entire corpus of written English is composed of just 100 words. However, the memorization of translations for 100 common words does give students commensurate control of the English language. The words must be understood and experienced in multiple meaningful contexts and in variable combinations to be known and usable. The fastest and most effective way to understand and experience variable usage of the most common words in a language is to read in that language. How can the text of a new language be made more comprehensible for language learners?

Prior inventions have tried to make foreign texts more understandable for language learners. Some disclosed inventions format translations with foreign text. Some disclosed inventions mix parts of understandable translations with parts of foreign text. Some disclosed inventions synchronize text with audio/visual media.

U.S. Pat. No. 6,438,515 discloses a system to chunk and translate text: a text can be made more comprehensible with translation chunks inserted within “a separate focal plane” between lines of the text. The large text is dark and easy to see, while the small translations are faintly colored and barely visible. The 6438515 specification of “bifocal” translation alignment is evidently of practical utility to language learners.

Yet the 6438515 claims do not encompass the range of printing scenarios. In high resolution color print environments, now commonly available in consumer printers, background colors may vary widely. It is possible to render translations bifocally with useful new processes, previously unknown and unclaimed.

While it is a significant improvement over known techniques and is useful to language learners, the 6438515 method to align chunk translations Is not optimal; to produce even single instances of aligned chunk translations using the 6438515 method, people are asked to manage a matching series of multiple returns inserted into each of two separate “source” texts. The method required the programmer to manage multiple files and store them in multiple folders identified in a complex naming convention.

In the 6438515 system, the presentation version and editable source text are separated. If a reader finds an error or wants to offer an alternative translation, the reader is asked to switch to a separate interface, and then go through a lot of unnecessary work to locate the desired point of edit. Correction of simple errors is impractical while the editable version is so separate from the viewable version.

No known technique combines alignable chunks of text and translation in one single editable preview. No known technique controls chunk translation alignment with a simple series of extra spaces between words. No subsequent invention since 6438515 is known to disclose a system to easily align, edit and produce chunk translations for language learners.

None of the known techniques provides a simple data format that both humans and machines can use, easily, to learn language.

None of the known techniques provides a simple method to identify and separate chunks of text.

None of the known techniques provides a simple method to correlate separate chunks of translation for each chunk of text None of the known techniques provides a simple means to input alignable chunk translation data.

None of the known techniques provide various methods to variably output constantly aligned and editable chunk translation data.

None of the know techniques provides means to achieve bifocal alignment in a full range of color printing environments with variable backgrounds.

None of the known techniques provides means to output alternating chunks of text and translation.

None of the known techniques provides a method to align chunk translations where the translations can be synonyms of the same language as the text.

None of the known techniques provides a very simple means to save alignable chunk translation data.

None of the known techniques provides an effective means to collect a corpus of chunk translation data.

None of the known techniques provides a method to control of both text chunks and related translation chunks within one single document.

None of the known techniques provides a method to consistently align chunks of translations with chunks of text, even in a wide variety of print and other output formats.

None of the known techniques provides an apparatus to align chunk translation rendered in simple monospace text.

None of the known techniques provides a method to manage chunk translations using virtually any common text editor.

None of the know techniques provides a method to control aligned chunk translation within common Textarea Input forms widely used on the Internet.

None of the known techniques provides an editable preview of bifocal chunk translations, where the text is, for example, twice the size of the translation.

None of the known techniques provides an apparatus that can process input from one single document to format chunk translations aligned in tables.

None of the know techniques provides means to align chunk translations synchronized in time with audio and audiovisual media.

None of the known techniques provides a simple method to quickly chunk translate authentic texts.

None of the known techniques provides a simple method of control to manage both normal bitext and alternative chunk translations of the same original source text.

None of the known techniques provides a simple method to control variable versions of a single text in chunk translation.

None of the known techniques provides a method to quickly and directly edit errors within an editable preview.

None of the known techniques can easily deploy existing machine translation systems to produce editable chunk translations automatically.

None of the known techniques offers sufficient ease of use to enable collection of an adequate corpus of chunk translation.

None of the known techniques provides a method and apparatus to improve automatic chunk translation produced by machines.

None of the know techniques can be used by machines to automatically produce chunk translations in a format that humans can easily edit and improve.

There is no known system to easily chunk translate text. None of the known techniques provides a simple method to separate a text into translatable chunks; associate translations with each chunk of text; control the chunks of text and the chunks of translation within one single document; align printable output of chunk translation in a plurality of useful formats; effectively harvest chunk translation data; and thereby instruct machines to produce better automatic chunk translations.

What is needed is a simple method to align editable chunks of translation with chunks of text; to control both sets of related chunks within a single, editable document; to print variable outputs of chunk translation in consistent alignment; so that translators can easily produce chunk translations; then share the chunk translations on the Internet; so that chunk translations may be varied and improved by a plurality of translators; thus producing and improving corpus of chunk translation data, which machines can employ to improve automatic production of chunk translations; so that language learners can more easily access chunk translations, and thereby learn language.

### SUMMARY OF THE INVENTION

The known prior art techniques do not accomplish the objectives and advantages afforded by the various embodiments of the present invention.

One objective of the present invention is to provide a simple data format that both machines and humans can use to learn language. It is an intent of the present method and apparatus to collect and organize human translation intelligence, in the form of an improving corpus of translation data which is unique to the special conditions of chunk translation. The simple data format, in accordance with the various embodiments of the present invention, enables humans to easily input data, while allowing machines to store, analyze, sort and learn from the data, and finally output increasingly accurate automatic chunk selection and chunk translation.

Another objective of the present invention is to provide an extremely simple method to specify and separate chunks of text, and then to identify and, separate specific chunks of translation which correlate with specific chunks of text.

Another objective of the present invention is to, thus, provide an extremely simple means to input alignable chunk translation data, so that machines, such as computers incorporating software, may then process the input.

Another objective of the present inventions is to enable chunk translations to achieve a bifocal format, where the reader must refocus to see the translation text, with texts of equal height and appearing in variable contrast to a variable background, including where the background is comprised of an image.

Another objective of the present invention is to provide an editable preview of bifocal chunk translations, where the monospace-rendered font is so styled where the text is, for example, twice the size of the translation, which both accommodates more room for translation information in association with each chunk of text, while also providing a pre-visualized preview of bifocally rendered chunk translations which can, importantly, be easily edited.

Another objective of the present invention is to process chunk translation data and output print presentations of chunk translation data, where each chunk of translation is consistently aligned with each chunk of text. Such alignment may be flush right, centered, or flush left; such alignment may place chunks of translation above or below the chunks of text, or otherwise be controlled according to individual user preference.

Another objective of the present invention is to provide means to present chunks of text in alternation with chunks of translation, or a configurable and automatic production of “code switching” between text and translation languages.

Another objective of the present invention is to provide means to produce full immersion same language chunk translations, where the “translation” is simply expressed as synonyms in different words of the same language.

Another objective of the present invention is to provide a simple and versatile means to save chunk translation data in computer memory, which is preferably shared on the global computer network or Internet, in such a way that such data may be employed to improve the production of automated chunk translations.

Another objective of the present invention is to provide a simple, robust and effective means to collect chunk translation data in a sufficient quantity to serve as a corpus which can be statistically analyzed, and so to result in the improving production of automated chunk translations.

Another objective of the present invention is to provide a simple means to control, within a single document, the contents of both the text chunks and the related translation chunks. Whereas in earlier methods, the text and translation were controlled in separate documents, they can now both be controlled within one single document.

Another objective of the present invention is to provide an apparatus to quickly and capably process chunked text and correlated, chunked translation input, and thereby align chunk translations in the most simple and universal computer font typestyles, commonly known as monospace type fonts.

Another objective of the present invention is to thus enable the vast majority of common text editors in current use to be employed to easily create, control, modify, edit, correct and improve single and/or multiple instances of chunk translation.

Another objective of the present invention is to thus enable chunk translation input to be managed within the ubiquitous Textarea Input forms used on the Internet to collect input from users of the Internet. Thus, no special software is required to install or manage in order to edit and improve instances of chunk translation.

Another objective of the present invention is to provide an apparatus that is able to read a single document containing chunk translation data, and from that single document then render precisely aligned chunk translations organized in borderless tables, as is commonly done in HTML, PDF and other print formats.

Another objective of the present invention is to provide a means to synchronize aligned chunk translations with audio and audio visual media, so that a language learner can see the texts while the language learner hears their sound.

Another objective of the present invention is to provide a method which is sufficiently simple so that authentic texts in a language, such as lyrics to songs, poems, stories, news and other such contents, can be easily chunk translated, shared and improved by multiple users of the Internet.

Another objective of the present invention is to provide a method and apparatus to separately manage and control normal bitext or parallel text translations in separate documents, while also controlling separate alternative chunk translations, in accordance with the present invention. Chunk translations have distinct needs, usage, flexibility, structure and parameters that are independent of normal bitext or parallel text translations.

Another objective of the present invention is to control variable chunk translation versions of one single text, including alternatively chunked text, a plurality of translations for each chunk of text, variation by translation language, dialect or slang.

Another objective of the present invention is to enable casual readers to easily correct small errors in either text or translation, without undue difficulty; one intended result, again, is to collect improving data which can be used to improve automated productions of chunk translation.

Another objective of the present invention is to provide a method and apparatus which are sufficiently simple so as to be easily learned and regularly used by humans, so that a body or corpus of chunk translation can be collected in sufficient quantity to enable increasingly accurate mechanical production of chunk translations.

Another objective of the present invention is to provide a method and apparatus to automatically produce chunk translations with increasing accuracy, and increasing customization in the service of individual human language learners.

Another objective of the present invention is to provide a method and apparatus to enable currently existing machine translation systems to easily align editable chunks of translation and text.

Accordingly, the present invention provides an apparatus and method enabling translators to specify and control chunks of text and related chunks of translation; where such “chunks” may include single words or multiple words; where chunks are identified simply by adding an extra space between them; where control of both sets of chunks is managed within one single, easily editable document; and where, even in a plurality of printed output formats, the related chunks of text and translation are constantly aligned; so that people can use the related and aligned chunks to easily compare words, using such comparisons to experience and learn new words and language. Users who are knowledgeable in both the text and translation languages can employ the present invention to more easily edit, manage, correct, update and improve chunk translations, so that others who are learning one of the languages can get more accurate translation information. “User-friendly” improvement of chunk translations also enables knowledgeable humans to instruct machine translation systems, thus enabling improving systemic production of and improving quality in chunk translation. The present invention makes it easier to use chunk translations, for both machines and for humans, to learn language.

### BRIEF DESCRIPTION OF THE DRAWINGS

Further objects and advantages of the present invention will become apparent from a consideration of the drawings and ensuing detailed description.

FIG. 1 shows a representation of a paragraph of text which can be managed with a computer and printed on paper.

FIG. 2 shows a translation of the text in FIG. 1; the translations can also be managed with a computer and printed on paper.

FIG. 3 shows the FIG. 1 text and FIG. 2 translation combined into one single document; each line of translation is printed below each line of text.

FIG. 4 shows the FIG. 3 text and translation, with a series of extra spaces added between segments or “chunks” of language.

FIG. 5 shows a flow chart of a computer program which reads chunked text and translation input and formats the chunks in variable text outputs and alignments.

FIG. 6 shows the FIG. 3 text and translation chunks now aligned in “simple monospace”, according to locations where extra spaces were added in FIG. 4.

FIG. 7 shows the FIG. 6 text and translation chunks now rendered in variable sizes and realigned in “bifocal preview” output.

FIG. 8 shows an edited version of FIG. 7: both the text and translation parts of the document have been modified; thus illustrated is a directly edited preview of aligned bifocal chunk translations.

FIG. 9 shows a framework or table border superimposed over the chunked text and translation information in FIG. 8 now rendered in a non-monospace font face and printed in “table chunk” alignment.

FIG. 10 shows FIG. 9 “table chunk” alignment without the superimposed table border; table chunk alignment can be directly editable with a customized chunk translation editor.

FIG. 11 shows a variably edited version of FIG. 7: now the “translation” expresses similar meanings while using different words in the same language as the original text

FIG. 12 shows the FIG. 7 languages reversed, where the normal FIG. 2 translation text is now chunk translated back to the original text language in FIG. 1.

FIG. 13 shows the FIG. 8 text alternating or “weaving” between the text and translation languages, in this example alternating every other chunk.

FIG. 14 shows the FIG. 8 text input as a paragraph and wrapped in a narrow window.

FIG. 15 shows the FIG. 14 text wrapped in a wide window.

FIG. 16 shows the FIG. 15 and FIG. 14 text with no wrap applied.

FIG. 17 shows the FIG. 15 text with a title and title translation included within the single source text document.

FIG. 18 shows a close-up of the FIG. 10 texts with horizontal scaling manipulated to enhance bifocal characteristics and function.

FIG. 19 shows a close up of the FIG. 18 texts, where the color of the translation text is manipulated to achieve the bifocal function upon a mid range tone background

FIG. 20 shows a close up of the FIG. 18 texts, where the color of the translation text is manipulated to achieve the bifocal function upon a variably toned background.

FIG. 21 shows a computer system for accessing the program shown in FIG. 5.

FIG. 22 shows a mobile computer system for controlling the program shown in FIG. 5.

FIG. 23 represents aligned and bifocally formatted texts timed in sequence with audio visual media.

FIG. 24 represents a single text file containing tile information, chunked text and translation contents, and includes metadata.

### DETAILED DESCRIPTION OF THE PREFERRED EMBODIMENTS

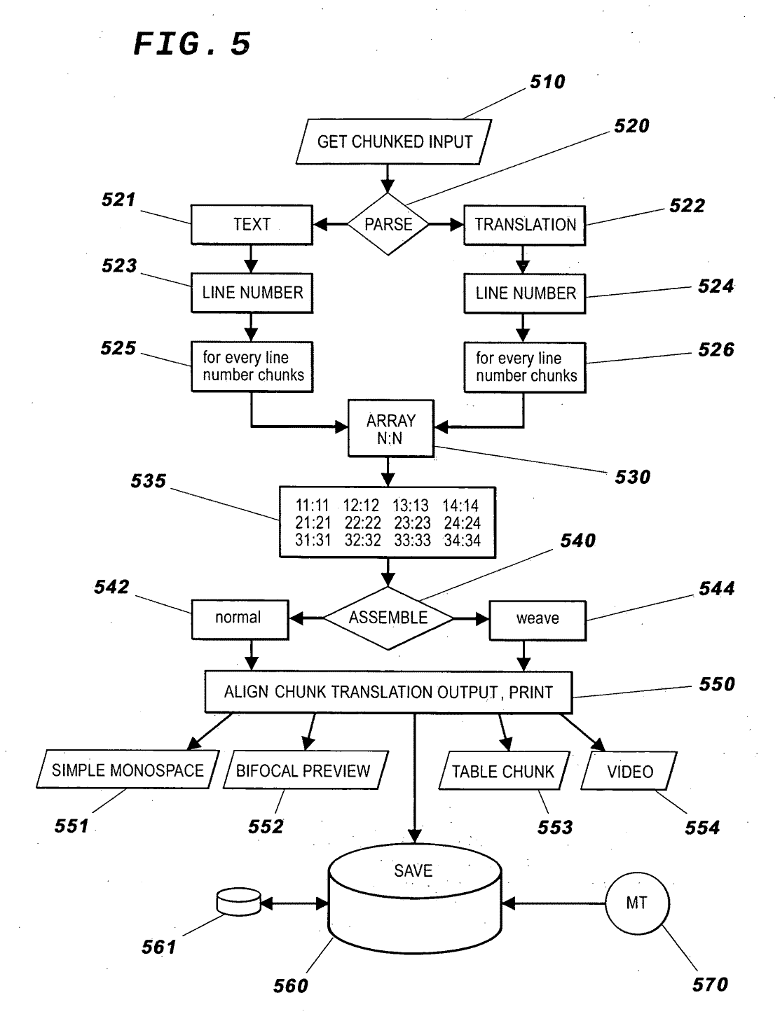

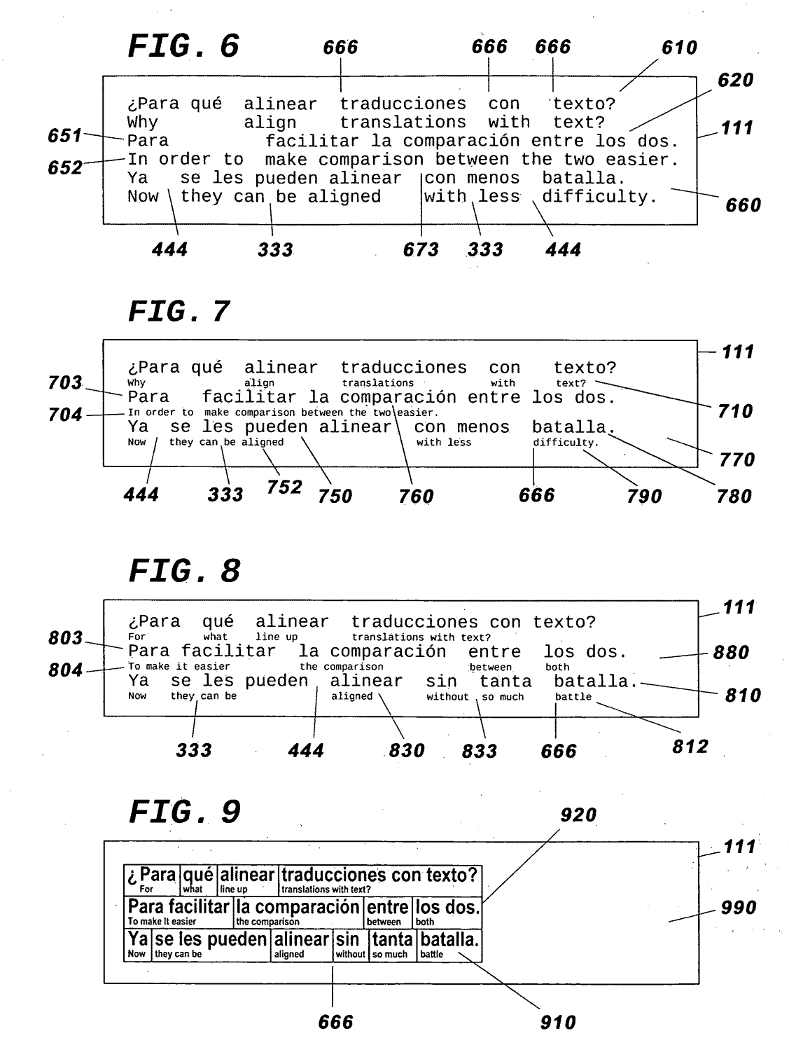

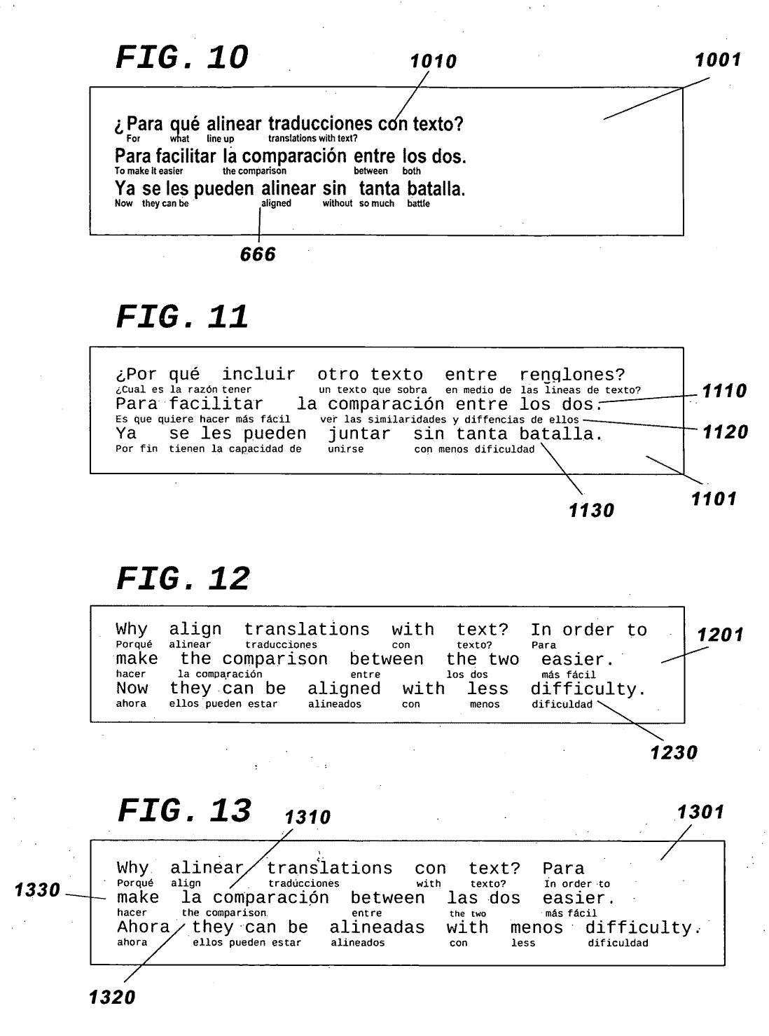

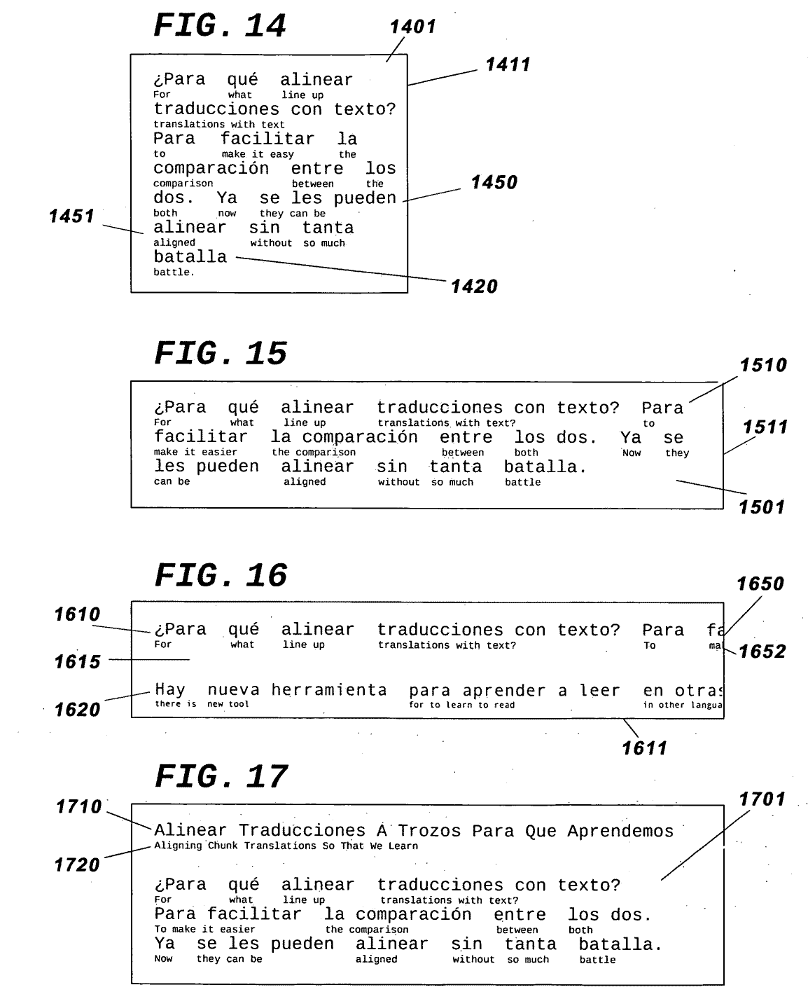

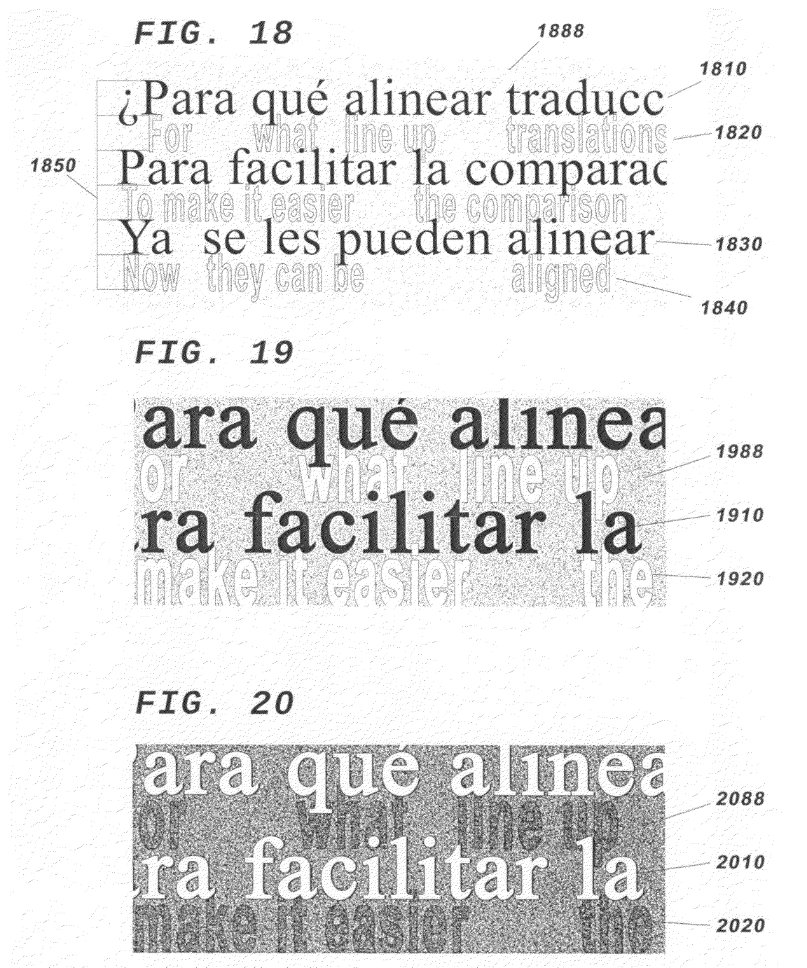

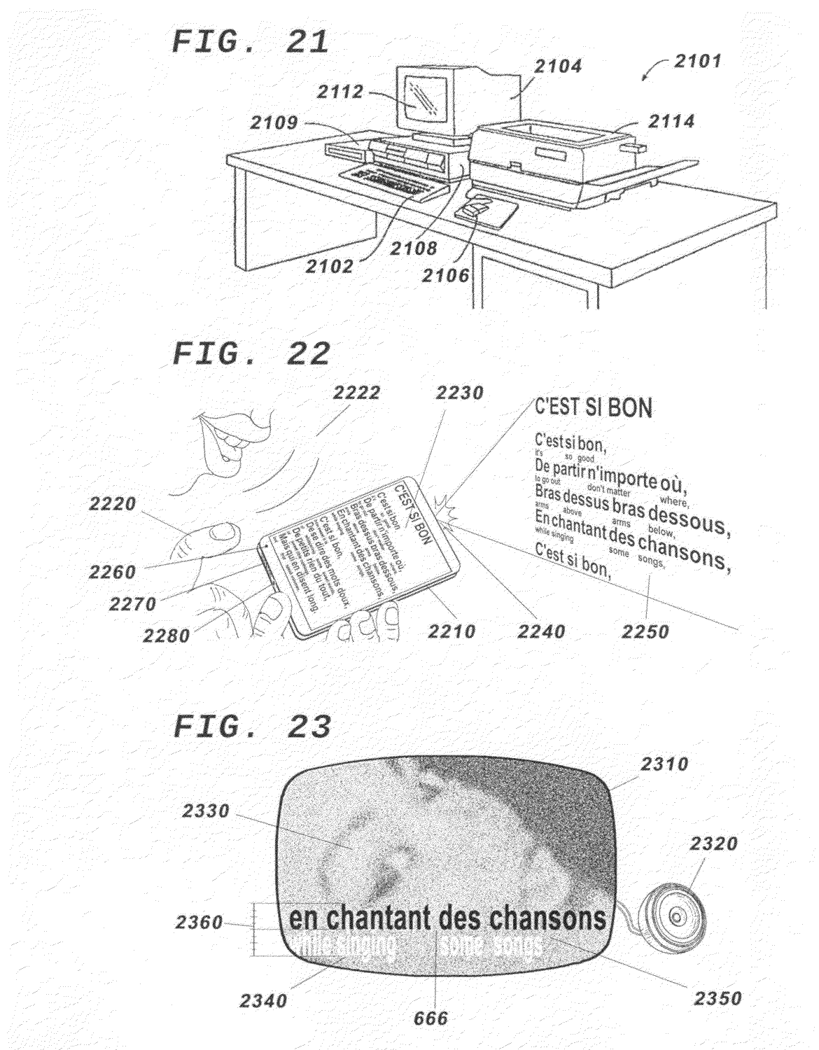

Briefly, as illustrated in FIG. 3, when a text and a translation are combined into a single document 333; and when each line of translation 320 is placed directly below each line of text 310; and when, as illustrated in FIG. 4, a corresponding series 488 of extra spaces 444 is added between related chunks of text and related chunks of translation, then a computer program, as is represented in FIG. 5, can locate and array 530 the corresponding chunks of text and translation, then align the chunks consistently in variable outputs 550, including those represented in FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 21, FIG. 22 and FIG. 23.

A general depiction of one example embodiment of the present invention is shown by the illustration provided in FIG. 8, which combines a text and a translation into one single and editable document 111, while printing segments or “chunks” of translation 812 in alignment with corresponding chunks of original text 810. Printing editable chunks of translation in alignment with editable chunks of text enables a reader to easily compare the aligned chunks. It also enables the reader to easily edit the text and/or the translation. The method and apparatus can read the edited chunk translation input and realign the output; constant alignment is preserved, as demonstrated in FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 21, FIG. 22 and FIG. 23

The method and apparatus make aligned chunk translations easy to create, use and improve. Any simple text editing program that permits more than one extra blank spaces 444 to be included between words, as illustrated in FIG. 4, can be used to define sets of corresponding chunks; separation of chunks and management of their contents, in both the text and the translation, is fully controlled within one single document 111, and can be aligned 666 as shown in FIG. 6. Any text editing program that enables monospace fonts to be styled in variable sizes, as is illustrated in FIG. 7, can be used by the method and apparatus to manage directly editable previews of bifocally rendered chunk translations, which can then be printed with customized fonts and in precise alignment, as illustrated in FIG. 10. Easy control of simple documents manageable in common editing environments enhances opportunities for machines to gather data 560 needed to improve the automatic production 570 of chunk translations in accordance with the present invention.

Considered in more detail, the present invention provides a simple method and apparatus to enable a user to control and edit a text and translation within a single document 111; in addition, the user can correlate specific segments or “chunks” of text 420 with chunks of translation 422 within the single document; further, the user can print 550 related chunks of text and translation in consistent alignment 666, while in a plurality of output environments, including common Textarea Input fields, such as those commonly used on the Internet to collect input from users.

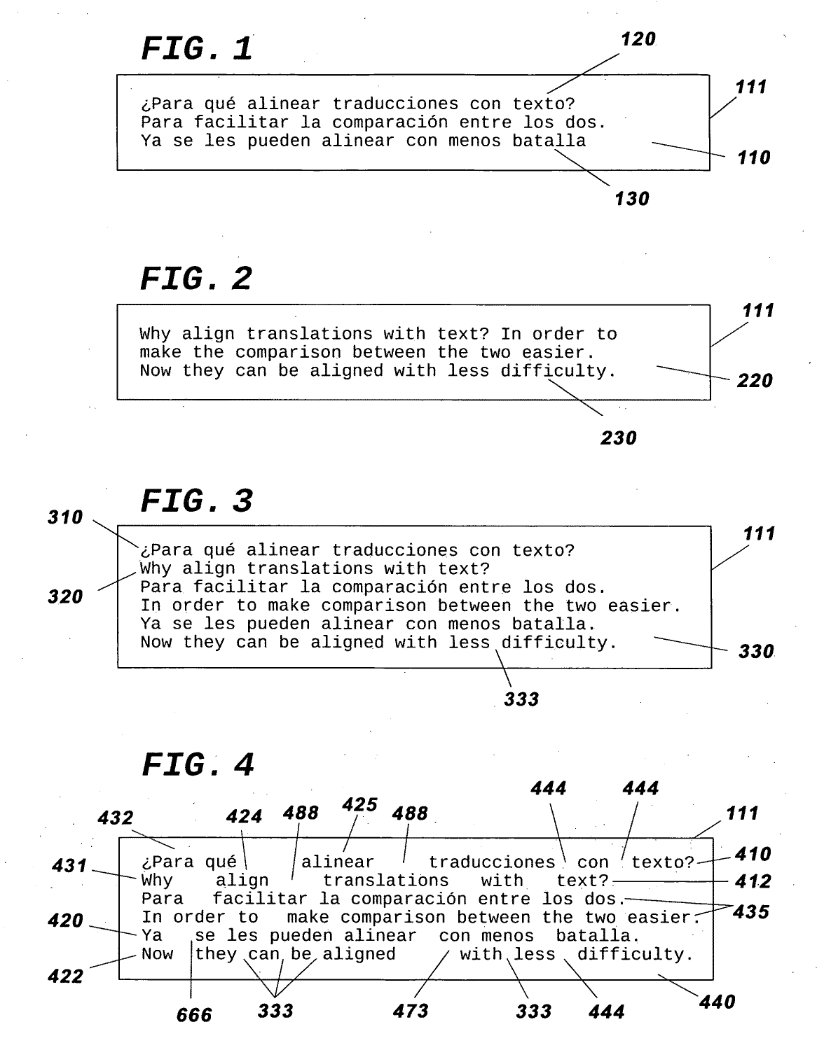

Key words and terms are used to describe, in full detail, the preferred embodiments of the present invention. Clear definition of such terms may eliminate some unnecessary ambiguity within this description and disclosure. For example, since a “translation” is typically rendered in text, there may be cause for confusion when referring to a “text”, particularly when a single document 111, in terms of the present invention, can contain both “text” and “translation” 330. Within the scope of this specification, the word “text” always refers to the original text as represented in the example of FIG. 1. Any exception to this rule is explicitly stated, if and when such an exception may be made. When this specification refers to both the text and the translation together, it may refer to the combined body of words as “texts”.

Another example of a term often used in this specification is “translate” and “translation”. Normally, these terms are understood to mean a similar idea expressed in words of a different language. Within this specification, the terms may be used more liberally. For example, as is illustrated in FIG. 11, a “translation” 1120 can include the expression of a similar idea which is made in the same language as the original text 1110. Thus, when the words “translate” or “translation” are used within this specification, they should be understood to signify a meaning analogous to “a separate word or set of words which carries or refers to a similar meaning or message”. So within the scope of this specification, a “translation” language may be same language as the original text, or a similar dialect, or an altogether separate language.

If confusion arises, this specification may refer to the “text” as “strong-styled” and “translation” as “weak-styled.” The strong style is formatted to be easily visible, while the weak style is formatted to be barely visible. If, for example, in FIG. 7, the reader already knows the language of the easily visible strong style text, the reader may opt to align unknown language using the less visible “weak style”. An intended purpose of the present invention is still served: a reader may more easily compare chunks of known text with aligned chunks of unknown text. In another example, illustrated in FIG. 13, the languages of both the strong style and the aligned weak style text “weave” or alternate. Thus, the less visible parts of the presentation can be referred to as of the “weak style”, while the more visible parts can be referred to as of the “strong style”.

Another key term within this specification is “bifocal” formatting of text and translation, where the strong-style text is easily visible in relation to the aligned weak style translation, which is intentionally formatted to be as faint as possible, though still visible if the reader makes the effort to look closely. Examples of more effective and versatile bifocal formats are suggested in FIG. 18, FIG. 19 and FIG. 20. When viewed in low light conditions, the weak-styled texts become nearly invisible. Testing has proven that there is great utility in this feature. Aligned texts are most effective when they are repeatedly viewed; when viewed in lower lighting conditions, great effort is required to read the weak styled translation text. When viewed in bright lighting conditions, less effort is required. Reading the texts repeatedly, in variable lighting conditions, challenges the reader to remember the weak-styled translation, and thus strengthens the reader's knowledge of the new language.

Another example of a term often used with this specification is “align”, which, within this specification, to be clear, neither pretends nor intends to signify the complete, full “bitext alignment” or “aligned bitext” in the strict linguistic sense, where analogous words and even parts of words are related between a text and its translation. As should be clear in the intended scope and detail of the present disclosure, the term “alignment” is herein used to relate analogous words and phrases, but not, however, fully relating analogous parts of words, such as individual syllables or verb tenses or conjugations; “alignment” is used less academically and more graphically.

Another example of a term often used within this specification is “chunk”, which is herein used to mean a single word 610 or group of words 620. Other interchangeable labels for chunk as defined here can include “word or group of words” or “word or phrase” or “segment of text” or “text string” or “string”. This specification often uses similarly intended terms flexibly derived from the term “chunk” used as a root word. For example, the process of breaking a text into separately translatable words and/or groups of words can be called: “chunking a text”. Similarly, a translation can be “chunked” into words and/or word groups that refer to or which have analogous meaning to specifically related “chunks” of text.

A “chunk” is a “single word or group of words” which can be translated to another language; an idea or “chunk” expressed in one language may have a different word order than a related translation chunk expressed in another language. For example, in one language a modifier may precede a noun, whereas in another language, the noun may precede the modifier; but combining both modifier and noun into one translatable chunk allows one single alignment in each of the two separate languages. Any word or group of words that can be translated to another language is a “chunk”.

Another example of a term often used within this specification is “chunk translation”, which can refer to both the overall process and also to individual results produced by the present system. When referring to resulting products, the term “chunk translation” may refer to one specific chunk of translation in alignment with one specific chunk of text. “Chunk translation” is more often used to refer to a full series and set of aligned text and translation chunks, which combine to form a fully “chunk translated” text. The entire process disclosed in the present application can be labeled, called and known as an apparatus to “chunk translate”, or a method of “chunk translating”.

Chunk translations can be separate from normal translations. Normal translations 220, as seen in FIG. 2, produce independent, translated texts that sound complete and normal in the translation language. As detailed below, chunk translations are not required to sound normal; they may even sound odd. Chunks of translation should convey the intent of related chunks of text as they are used in the context; but chunks do not need to be grammatically perfect in the translation language; the translation chunks are used to understand the intent and then, where possible, the structure of the original text language, chunk by chunk.

The process of chunk translation starts with a text, as represented in FIG. 1. In the case of FIG. 1, which is used as an example to illustrate a “foreign” text, the example text appears in the Spanish language. This example text could equally be represented in another language, such as French or Portuguese, or perhaps even Mandarin or Korean. This example text could as well be represented in English, or in a dialect of English, such as Hillbilly or Pirate or Ebonics or Cockney.

The text example could be any text in any written language that can accept more than one space between chunks. Note that FIG. 1 represents a relatively brief sample of a text. Each word is separated by a single space. The editing platform 111 must allow for more than one space to be inserted between any two separate words. This example could variably include an extensive alternative text, multiple paragraphs, lyrics, or other text. Almost any translatable text contents could be used. Again, the key requirement is that normal expression of the “unchunked” text includes no more than one space between words.

The translation example could be in any written language which can separate words with single empty spaces 333. FIG. 2, also used as an example, shows a translation 220 of the ideas represented 110 in FIG. 1. The translation language in FIG. 2 is English. Again, the translation in FIG. 2 is shown as an example that is representative of any translation in any language or dialect that normally separates words by no more than one single space 333, or a language such as That, which does not normally separate words by spaces. Any such language can then be used as a reference from which to provide chunk translations, in accordance with the preferred embodiments of the present invention.

An added extra empty space 444 between words can be used to separate chunks of text. The inclusion of more than one space between specific words 431 or groups of words 432 can also be used to identify separate chunks of translation. The addition or inclusion of an extra space or more between words or groups of words 444 can be interpreted by a computer program, as illustrated in FIG. 5, as a “chunk” of translation 522, which can then be aligned with a corresponding chunk of text 521. Thus, by adding one or more extra space 444 between specific chunks, according with the preferred embodiment of the present invention, any single word 431 or group of words 432 can be defined as a segment or “chunk” of language, which can then be chunk translated, and then aligned 666 in chunk translation.

The added empty space(s) 444 can separate a single word, or a group of multiple words. As stated above, a “chunk” can be any single word, or any group of multiple words. Thus, a specific single word 431 can be defined as a chunk, by including more than one space 444 between this single word and any other words in separate chunks located upon the same line 410, 420. And also a specific group of words 435 can be defined as a single chunk, by maintaining single spaces 333 between all the words in the said group, but then surrounding the group or “chunk” with at least one extra space, and so adding up to a minimum total of at least two spaces 444 between chunks.

In traditional translation environments, a text and translation are managed separately. For example, in “parallel text” presentations, the translation 220 is printed apart from the original text 110, such as in a separate column, on a separate webpage or piece of paper. A text 110 and translation 220 are often saved in computer memory as separate documents with separate titles. Thus, a text 110 as represented in FIG. 1, and a corresponding translation 220, as represented in FIG. 2, are commonly understood to be separate. FIG. 1 represents a normal text, which can be translated into another set of words or into another language, as illustrated in FIG. 2.

Text and translations can also be managed within a single document. FIG. 3 shows a text and translation combined within a single document 330. Under each full sentence of text 310, there is a full sentence of translation 320. Such a combination of text and translation is known to be practiced in the field of Linguistics. Linguists can combine text and translation in “interlinear bitext” presentations; which are used to “align” parts of language between the text and the translation.

Chunks of text and chunks of translation can be identified within a single document. FIG. 4 shows the exact text 110 and translation 220 found in the single representative document illustrated in FIG. 3, but with a critical exception: where before, in FIG. 3, there was no more than one single space between any two words 333, there is now a series 488 of extra spaces 444 added between specific words and specific groups of words; a corresponding series of spaces is added to be included within the translation contents.

Identified chunks are separated simply by adding extra spaces 444 between them. In both the text and the translation, as illustrated in FIG. 4, words or groups of words are separated from each other by the inclusion of at least one extra space 444, thus totaling at least two empty spaces between them 444. Within the line of original text, there can be a large number of spaces between separate chunks 444, or there can be only one extra space 444 between chunks of text; what is required is that there be at least two (2) spaces 444 between any separate chunk of text. Within the line of translation, there can be a large number of spaces 444 between separate chunks, or there can be only one extra space 444 added to separate the chunks of translation; what is required is that there be a minimum of at least two (2) spaces 444 between any separate chunks of translation.

A corresponding series 488 of extra spaces correlate specific chunks of text with specific chunks of translation. “Corresponding series” simply means each line of translation should have the same number of chunks as the line of text which it translates. For example, if a single line of text 410 has five chunks identified within it, then the corresponding line of translation below it 412 should also have five chunks. Thus, as in FIG. 4, the extra spaces added 444 before and after the chunk “alinear” 426 correspond with the extra spaces before and after the word “align” 425. “Series” means that, for every number of chunks within a line of text, there are an equal number of chunks within the corresponding line of translation. Thus, the program described in FIG. 5 can array 530 each specific chunk of text with a corresponding specific chunk of translation.

It does not matter if there are more than two spaces 444 between chunks. As can be seen in FIG. 4, there are areas with single spaces 333 between words and there are areas with two or more spaces 444 between words. In some cases, there are more than four spaces between words of text. In other cases, there are more than four spaces between words of translation. In some cases, there are only two spaces between words of text. In some cases, there are only two spaces between words of translation. In some cases, a chunk of text may coincidentally align 666 with the corresponding chunk of translation. In some cases, a chunk of text may temporarily align with a non-corresponding chunk of translation.

When finding chunks, the program simply finds any set of two or more spaces 444. While there are many possibilities in the number of spaces 444 between words, the computer program represented in FIG. 5 interprets chunk translated input spacing in only one of two ways: if there is one single space between any two words 333, then those words are part of the same chunk; and if there is more than one space between any two words 444, or if there are at least two spaces between any two words 444, then those two words or groups of words are understood to be in separate chunks.

The program automates the alignment of both text and translation chunks. While people can with some effort accurately align chunks of text by hand, the computer program can be used to more easily automate the process. As a human editor or typist learns to understand and use the program, the typist can input or type a chunk translated text almost as quickly as one can input or type a normal text and write a normal translation. The typist has no need to switch between separate documents 110, 220; the typist needs only to add at least one extra space 444 between separate chunks of translation 431 and/or separate chunks of text 432.

So human users can easily chunk text and align translation chunks. People are not required to carefully align 666 chunks of translation with related chunks of text. Simply adding one or more extra spaces 444 between the chunks is sufficient; the computer program represented in FIG. 5, in accordance with the present invention, identifies, relates and arrays each chunk in each line of both text and translation, and then can precisely align 666 chunks of text with chunks of translation, and print 550 the resulting chunk translation in a plurality of constantly aligned outputs, including the print outputs illustrated in FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 21, FIG. 22 and FIG. 23.

An implementation of a computer system currently used to access the computer program in accordance with one embodiment of the present invention is generally indicated by the numeral 2101 shown in FIG. 21. The computer system 2101 typically comprises computer software executed on a computer 2108, as shown in FIG. 21. The computer system 2101 in accordance with one exemplary implementation is typically a 32-bit or 64-bit application compatible with a GNU/Linux operating system available from a variety of sources on the Internet, or compatible with a Microsoft Windows 95, 98, XP, Vista, 7 or later operating system available from Microsoft, Inc. located in Redmond, Wash. or an Apple Macintosh operating system available from Apple Computer, Inc. located in Cupertino, Calif. The computer 2102 typically comprises a minimum of 16 MB of random access memory (RAM) and may include backwards compatible minimal memory (RAM), but preferably includes 2 GB of RAM. The computer 2108 also comprises a hard disk drive having 500 MB of free storage space available. The computer 2108 is also preferably provided with an Internet connection, such as a modem, network card, or wireless connection to connect with web sites of other entities.

Means for displaying information typically in the form of a monitor 2104 connected to the computer 2108 is also provided. The monitor 2104 can be a 640.times.480, 8-bit (256 colors) VGA monitor and is preferably a 1280.times.800, 24-bit (16 million colors) SVGA monitor. The computer 2108 is also preferably connected to a CD-ROM drive 2109. As shown in FIG. 19, a mouse 2106 is provided for mouse-driven navigation between screens or windows. The mouse 2106 also enables students or translators to review an aligned text presentation and print the presentation using a printer 2114 onto paper or directly onto an article.

Future means for displaying aligned chunk translations, in accordance with the present invention, may include voice controlled portable tablets and/or cell phones equipped with Pico projectors, such as is shown in FIG. 22. The mobile device 2210 may operate on future extensions of a variety of current operating systems, such as Google's Android, Windows 7 mobile, Apple's iTunes and GNU/Linux systems. The mobile device can be equipped with a microphone 2260 and accept user input via voice commands 2222, enabling the user to access existing chunk translation alignments, edit them and/or create new instances of chunk translation alignment. Alternatively, the mobile device 2210 may accept user input from the user's finger 2220 and a touch screen 2230. Upon creating or locating a specific aligned chunk translation, the user may then proceed to print copies wirelessly, for example using Bluetooth technology.

Alternatively, the user may employ a Pico projector 2040 implemented within the mobile device 2210 to project a luminous copy 2250 of the aligned chunk translation upon a surface such as a blank wall. The device preferably includes a speaker 2270 and headphone socket 2280, so that the user can hear the words as they are projected.

Another means for displaying aligned chunk translations is superimposed over video, as is illustrated in FIG. 23. The video contents can stream over the Internet, for example from web sites such as YouTube. Alternatively, the video contents can be broadcast, or delivered by cable systems. What is required is an electronic display 2310, such as a computer monitor 2104 or a television monitor and a speaker 2320; thus moving images 2330 and sound can be transmitted and synchronized with the aligned texts 2350. In accordance with the present invention, the alignment 666 of the strong style and weak style texts is consistent with other disclosed embodiments. The height 2360 of both the strong and weak styles is similar; the horizontal scaling of the weak style 2340 is narrowed by approximately 66% in comparison to the strong styled text; and the weak style 2340 contrasts with the background less than half as much as the strong style.

A preferred embodiment of the present invention provides a computer program running at a website for creating and providing access to provide chunk translations in alignment. The computer program is preferably accessible through an Internet interface, using an HTTP or other Internet protocol. Other versions of the computer program can be, in accordance with the present invention, implemented to run directly upon a single computer system such as that shown in FIG. 21, workstation computers capable of formatting books and magazines which can be printed on paper and distributed for retail sale, or emerging computer devices, such as electronic book devices like Amazon's Kindle, Apple's iPad, information kiosks, mobile devices such as shown in FIG. 22, and other devices, as they become available. Such versions of the computer program are preferably downloaded directly from the Internet. The computer program implements the method in accordance with the present invention, which will now be described in conjunction with the flow chart which appear in FIG. 5

FIG. 5 shows a program that consistently aligns the related chunks. FIG. 6 shows a simple example of aligned chunk translation output 660. Where in FIG. 4 the chunks of text and the chunks of translation were not necessarily aligned 473, meaning that they did not line up into orderly rows, now in FIG. 6 each chunk of translation is aligned under each chunk of text. For example the chunk of text “con menos” 673 is now aligned with the chunk of translation “with less” 673. Most of the drawings show chunks of translation in alignment 666 with related chunks of text. This alignment is achieved by the computer program shown in FIG. 5.

The program arrays chunks of text and translation and aligns them in variable print formats. As seen in FIG. 5, the program separates text and translation lines 520 and separately numbers each line 523, 524; then the program finds and numbers each chunk on each line of both text 525 and translation 526; then the program combines and arrays the line numbers and chunk numbers 535; and the program thus relates each and every corresponding chunk; so then the program can align the chunk in multiple print outputs 550; and also the program can save the data 560, in order to collect a corpus which can be statistically analyzed and used to produce automatic chunk translations 570.

First, the program separates the translation from the text. The first line which contains text contents is interpreted by the program to be a line of text 410. A line with contents immediately below a text line is interpreted to be a line of translation 412. A line with contents immediately below a line of translation is interpreted to be another line of text 414. Thus, the program understands text and translation to appear on every other line, with text on the “odd” numbered lines and translations on the “even” numbered lines. The program interprets empty lines 1615 as empty lines, and resumes interpreting any content containing subsequent lines 1620 as text on any first line below any empty lines. Thus, the program can interpret text formatted as paragraphs, lyrics, poems, ordered lists, “bullet points” and similar arrangements with relatively few words on each line of text. In any paragraph, multiple sentences of text are all contained and included upon one single unwrapped line 1650. Thus, the next line immediately below the text can contain a translation of the text, also rendered multiple sentences upon an unwrapped single line 1652. A new paragraph 1620 is started when a line below any empty line 1615 is found by the program.

Text is separated from translation in both lyric and paragraph formats. The human user does not need to differentiate between either lyric formats or paragraph formats. For illustration purposes, the FIG. 8 example represents editable chunk translation arranged in a lyric format, where the lines of the texts are typically limited in width. Lyric formats are similar to poetic formats. Paragraph formats, on the other hand, typically contain longer lines and even several sentences in sequence. Standard text editors use the word-wrap function to accommodate the full paragraph within a limited display width 1411.

Paragraphs can be managed with chunk word wrap. The word wrap function inserts returns in the paragraph text 1450, so that it may continue upon subsequent lines below 1451. FIG. 14 shows the FIG. 8 text in a narrow page width 1411; word-wrap has inserted many returns. FIG. 15 shows the FIG. 8 text in a wider page 1511; word-wrap has inserted fewer returns. FIG. 14 has seven lines of chunk translation. FIG. 15 has three lines of chunk translation. A customized simple text editor can manage word wrapping of chunk translation input as illustrated in FIG. 14 and FIG. 15: when a chunk of text or translation does not fit within a limited width of a display, the chunk continues on every other line; the chunk must skip a line to continue consistently as either text or translation. Thus, the separate line in between is not interrupted; text and translation lines continue to alternate as expected, where within each paragraph, the text lines have odd numbers, followed by even numbered translation lines below; the chunk translation word wrapping functions in variable display widths 1411, 1511 as is shown in FIG. 14 and FIG. 15. Note that FIG. 16 shows the FIG. 14 and FIG. 15 chunk translations with the word wrap function disabled.

Chunk translation input simply requires two lines: one line is text, the other line is translation. In FIG. 16, with the word-wrap function disabled 1650, no extra returns are included in the lines of input. Due to the limited width of display 1611, both the text and translation lines appear to be truncated on the right side 1650, 1652. Still, the entire contents of the FIG. 15 text are contained within two input lines in FIG. 16; their full contents can be accessed via a computer display and use of horizontal scroll bar, or by using the right and left arrow keys, which are accelerated when used in conjunction with the CTRL key. Note that while the program can easily be configured to interpret the first line as translation and then the second line as text, within one preferred embodiment, as illustrated in the drawing figures, each translation line is consistently located not above, but below each text line. The two input lines may combine to form one combined “line” of chunk translated lyrics; the two input lines may combine to form chunk translations of multiple sentences contained within one paragraph, which can be variably wrapped 1450 as illustrated in FIG. 14 and FIG. 15, or unwrapped 1650 as shown in FIG. 16.

Multiple paragraphs or stanzas are easily controlled by the system. As stated elsewhere, the illustrations are provided as brief examples. Multiple paragraphs are easily handled, as are stanzas of poems and choruses of lyrics. In FIG. 16, for example, a new paragraph 1650 is represented as starting below one or more empty lines 1615. So long as a chunked translation line is constantly above or below a chunked text line, the texts can easily be separated into text and translation lines.

Titles can be easily managed. When the default title for a document is the first chunk of text, then titles and title translation can be included and managed within the single input file. Again, the program can recognize the first chunk in the first line as text input; while recognizing the first chunk of the next line down below as related translation input. In one preferred embodiment, which is illustrated in FIG. 17, the title 1710 and translation of the title 1720 are not chunked or separated into single words or groups of words; such unchunked titles can be regularly placed on the first line, with the unchunked translation located upon the subsequent line. Thus, the default title of any document can be the first chunk of text with its corresponding translation. In addition to convenient title management, use of the first chunk to identify a text has other uses.

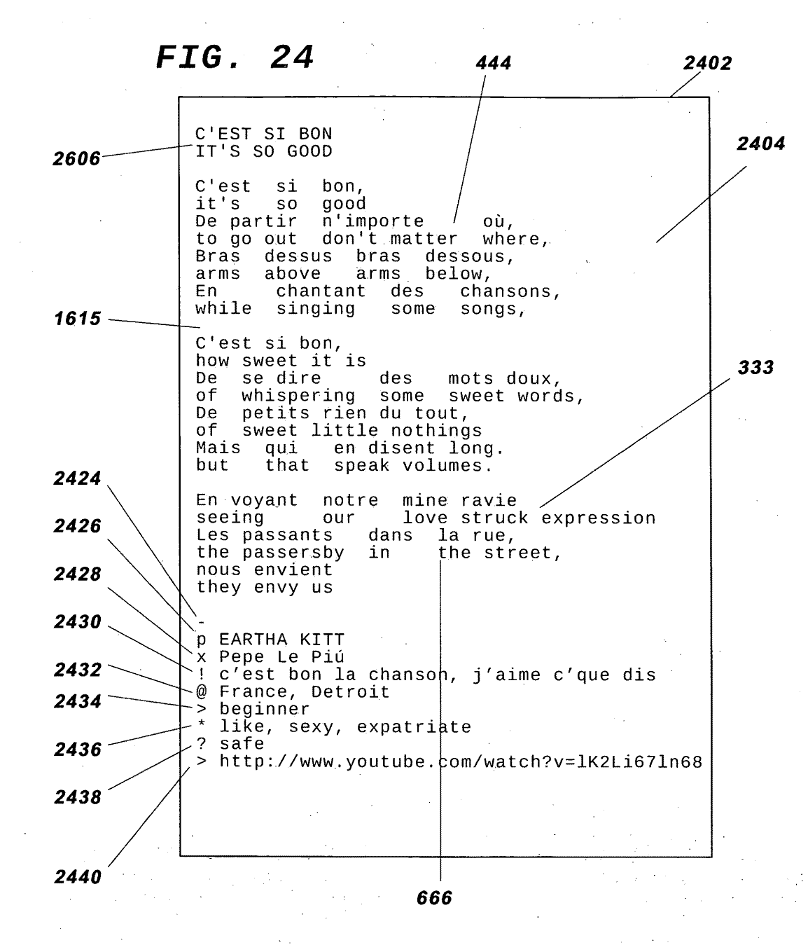

FIG. 24 shows a editable window single source file 2402, with contents 2404 that include a title and translation of the title 2602, chunked text and translation in alingment 666, where chunks are separated by more than one space 444, and empty lines 1615 between paragraphs or choruses. Below the described contents, new lines are appended, which include metadata, which a user can configure to inform a database. The metadata begins with a user-designated symbol, such as “-” 2424. Upon the next line below, the character “p” 2426 represents the performer. Upon the next line, the character “x” 2426 represents the translator; upon the next line, the character “!” 2430 represents a comment; upon the next line, the character “@” 2432 represents the region from where the text originates; upon the next line, the character “>” 2434 represents the difficulty level for a language learner; upon the next line, the character “*” 2436 represents tag information; upon the next line, the character “?” 2438 represents a content filter; upon the next line, the character “>” 2440 represents a linked resource, such as a Youtube video.

Thus, as illustrated in FIG. 24, a user can designate metadata, which can be interpreted to inform a database. Then, the user can populate the database with new information and data, using only a single text file. A single text file is convenient to manage on a personal computer, and then share with users of the internet. With a single text file, a user can, similarly to a blogging service such as Posterous.com, simply use an email to update and populate a database, without need to fill in specific fields of data information.

Popular sayings can be easily managed. Proverbs are especially useful to language learners, as they transmit wisdom across generations of language users. The method to manage titles described in the previous paragraph can be repurposed to manage comparison of full sentences with one normal translation and then the same sentence with multiple chunk translation alignments; in this manner, popular text fragments, sayings and proverbs can also be chunk translated.

Separation of text and translation lines is controlled in titles, essays, sayings, stories, songs, lists, lyrics, poems, and proverbs. Sayings can be analyzed and discussed. Titles can easily be included with complete chunk translated texts or songs. Texts may be organized in fragments, multiple sentences, paragraphs, lists and poetic verses; texts may include titles, such as the title of an article or essay or the title of a song or poem. In each of the variable cases described, in texts arranged as lyrics or lists, in texts arranged in paragraphs, in titles, and in texts arranged as fragments, idioms or sayings, the program can regularly sort and separate the lines of text from the lines of translation.

The program then numbers each line of text and translation. The alignment 666 in FIG. 6 and other figures is achieved by the computer program represented in FIG. 5. The program reads any example of chunked translation input, such as that represented in FIG. 4, and proceeds to execute several processes: first, the program separates the text 521 and translation 522 parts of the input and records them in temporary memory; each line of text is then numbered 523, and each line of translation is correspondingly numbered 524. For example, the first line of text 410 can be numbered as 1, while the first line of translation 412 can also be numbered as 1.

The program then finds and numbers each chunk of text and translation. After separating and numbering the related lines of text and translation, the computer program represented in FIG. 5 proceeds then to find all instances of two or more spaces between words 444; wherever more than one space between words is found, a new segment or “chunk” is created and given a number. This process is performed on both the text 525 half of the input, as well as the translation 526 half of the input. This number is added to the line number defined earlier 523, 524. For example, the first chunk on the first line of text can be numbered “11”, while the second chunk in the first line can be numbered “12”. Correspondingly, the first chunk on the first line of translation can be numbered “11”, while the second chunk on the first line can be numbered “12”. The first chunk on the second line can be numbered “21”, the second chunk “22”, the third chunk “23”, and so on.

The program then arrays these numbers, each linking to specified chunks of text and translation. Each chunk of text is linked numerically with each chunk of translation. For example, the numbered chunk “12” in a “text” row can be linked with the number “12” in a “translation” row. As illustrated in FIG. 5, the computer program can create an array 530 of matching sets of numbers 535 associated with specific chunks of both text and translation. Within this array, for example, the string “12:12” associates the second chunk of the number on the first line of text with the second chunk on the first line of translation. So then, to align the chunks of text and translation in a variable plurality of output formats 550, the program simply refers to the array of numbers 535 that it created, then fetches the associated text strings, and then proceeds to print them together 550, in alignment 666.

This array is used to fetch the chunks and align them consistently in variable output formats. As is illustrated in FIG. 6, FIG. 7, and FIG. 10, there are variable outputs 550 that require separate formatting of the array 535 created by the computer program in FIG. 5. It is also important to note that not all possible alignable output formats are listed here. The examples provided serve as evidence to show that the system can constantly align chunks in a plurality of outputs.

Users can, if desired, alternate the chunks to make explicitly bilingual texts. As illustrated in FIG. 13, the strongly styled “text” part of the total presentation can be configured to alternate with translation chunks. For example, in FIG. 13, one line of strongly styled text says “make la comparación between las dos easier” 1330. The configuration can vary the number of chunks alternated. The resulting explicitly bilingual “weaving” of words in both languages can provide a language learner with a familiar context of easily visible known words in association with less familiar new words. Each corresponding and equally alternating chunk of text or translation continues to appear in constant alignment 666. Whether or not a user alternates or mixes the chunks, the alignment 666 of the chunks and the variably printed output format remain the same.

Users can control the alignment. For example, the user can align the chunks to the left, centered, or to the right. Note that the lower left “alignment” 830 illustrated in the figures is preferred, but not the only useful embodiment. For example, if a user prefers, the program can be easily modified to align chunks of translation to appear centered directly under each chunk of corresponding text. Alternatively, the chunks of translations could be aligned flush to the right of each chunk of text. Alternatively, the chunks of translation could be aligned above the chunks of text. The preferred embodiment illustrated in FIG. 6 may be the simplest, but should not be understood as the only possible form of chunk translation alignment.

While the aligned outputs described in this specification are widely useful in common text editing and printing environments, the disclosed list is not limiting. Rather, it identifies representative common and useful text environments in which aligned chunk translation output can be produced with relative ease. The alignment formats listed also serve to show chunks in constant alignment while in variable outputs.

Aligned chunk translation formats can include “simple monospace”, “bifocal preview”, and “table chunk” formats. Each format has distinct advantages. Simple monospace aligns the most basic editable computer typography, which is commonly used in forms and “Textarea Inputs” on the Internet. Bifocal preview alignment aligns two different sizes of monospace rendered characters, which allows more space for translation content and also provides an editable preview of bifocal formatting. Table chunk alignments are not easily edited, but do enable precise alignment of translation chunks with text chunks, while function with standard text rendering formats like HTML and PDF.

“Simple monospace” alignment is simple and accurate. FIG. 6 represents the most simply aligned form of output: all separate chunks of text and/or translation must be at least two empty spaces apart 444. Thus, if a chunk of text is longer than the corresponding chunk of translation, then additional extra spaces are appended to the chunk of translation, to enable the following chunk of text and corresponding chunk of translation to both begin at the same point of horizontal alignment. Conversely, if a chunk of translation is longer than the corresponding chunk of text, then additional extra spaces are appended to the chunk of text, to thus enable the following chunks of text and translation to both begin at the same point of horizontal alignment.

“Bifocal preview” alignment is generally accurate. FIG. 7 represents a slightly more complex form of aligned output when compared to the FIG. 6 example. The text portion 750 has been enlarged and the translation 752 part has been reduced in font size, so that now more characters of translation can be related to each chunk of text. When the text and translations are rendered in monospace font, and when the text is twice the size of the translation, (for example when the text is sized at 14 points and the translation is sized at 7 points), then, when rendered in monospace fonts, each character of text can accommodate two characters of translation. So the smaller chunks of translation can easily be aligned 666 with the larger chunks of text, again simply by requiring a minimum of two spaces 444 between any two chunks, then appending empty spaces are added as needed either to the chunk of translation or to the text chunk.

“Table chunk” alignment precisely aligns chunk translations. FIG. 9 illustrates a precisely alignable output rendered in tables, as is standard in HTML, PDF, spreadsheets and other common array formats. Each chunk of text and related chunk of translation are contained in a separate cell 910, within the table that assembles the cells into a complete chunk translation presentation 990. The framework is explicitly described by the superimposed grid 920 shown in FIG. 9. Note that in FIG. 9 and FIG. 10, which represent a preferred embodiment of final presentation print output, the font face 1010 is not a monospace font; any font face can be used in tabled chunks, typically without harming the chunk alignment 666.

Each specified output has advantages and disadvantages. Table chunk aligned text and translations are not easy to edit, but can produce refined presentations in precise alignment. Bifocal preview alignment is not always precise, but does offer an easily editable preview of more readable table aligned chunk translations. Simple monospace alignment is, like many forms of source text, not the easiest to read, but it can function in most of the most basic types of input fields, such as Textarea Input fields commonly used on the Internet.

Table chunk alignments are easy to read, but are not easy to edit. Typically, a user is required to control a separate “source text” document, and then toggle back and forth between this editable source text and the “target” preview or print version of the document represented in FIG. 10. While there are some means in prior art available to directly edit chunks of text and translation within a pre-defined block of a previewed presentation, there is not, prior to the present invention, a comparatively simple means to edit and control the chunking 444 and alternative rechunking of the original text 110.

Simple monospace alignment is easy to edit, but not easy to read. Reading can be difficult where the chunks of translations 652 are longer than the chunks of text 651. As specified above, the alignment process can force many extra spaces to be appended to text chunk. Unusual and large gaps in the text make the reading of it more difficult and less natural.

Bifocal preview alignment is easier to read and easier to edit. While not as refined as the FIG. 10 example, the bifocal preview alignment shown in FIG. 8 is easier to read that the simple monospace alignment. But unlike FIG. 10, FIG. 8 bifocal previews of chunk translations can be as easily edited and realigned using many existing and readily available text editing programs.

Bifocal previews are aligned 666 using monospace font faces. Font faces such as Courier, Andale Mono, Liberation Mono and the like are called “monospace” fonts because each character, including empty spaces, is exactly the same width. Non-monospace typefaces such as Arial or Times have variable widths for separate characters: for example, the letter “m” is wider than the letter “i”. Non-monospace fonts cannot yet be accurately aligned 666 without the use of tables 920. This limitation does not apply to monospace fonts.

Simple monospace alignment can be controlled in Internet Textarea Input fields. The aligned output represented in FIG. 6 is useful: it allows aligned chunk translation input to be managed in standard Textarea Input fields, such as those in standard use on the Internet. Typically, Textarea Input forms render text in default monospace font typeface, while also allowing more than one space to be included between words. Thus, in accordance with the preferred embodiments of the present invention, Internet standard Textarea Input text editing environments can be used to create and manage chunked text translations.

Constant width enables monospace fonts to align easily. Constant character width common in monospace fonts is used to align 666 both the simple monospace and the bifocal preview output of chunk translation formats.

Aligning each chunk translation in simple monospace is straightforward. First, to find the longer chunk, total the number of letters and spaces between them, add two spaces, and then subtract the number of letters and spaces in the shorter chunk. The resulting number is the number of empty spaces that must be added to the shorter chunk, so that the following chunk can start at the same point of horizontal alignment. Obviously, if both chunks have the same amount of characters, or if no more chunks remain on a particular line, these operations are not performed. Thus, the correct number of spaces is added to the shorter chunk.

Alignment of bifocal monospace chunks is also simple. Compare the chunks, if the shorter chunk is a translation, then total the number of letters and spaces of the text chunk (including the two spaces after the chunk), then multiply times two; then subtract the total number of characters and empty spaces in the translation chunk; then add the remaining number of spaces to the shorter chunk of translation, to thus align the subsequent chunk of translation and text. If the shorter chunk is text, then total the number of letters and spaces in the translation chunk (including four spaces after the translation chunk), then divide by two; from that total, subtract the number of characters and spaces in the text chunk (not including the two spaces after the chunk); then add the remaining number of spaces to the text chunk, in order to align the subsequent chunk of text and translation. Thus, when the translation chunk is half the size of the text chunk, the correct number of spaces is added to the end of the shorter chunk.

Monospace fonts can appear in variable sizes, including half sizes. Half sizes means many monospace sizes can be 50% the size of others. For example, one font size may be a typical 12 pt font and have a half size font which is 6 pt. Or 7 pt is the half size font for 14 pt sized font. As detailed in the paragraph above, half size monospace fonts enable predictable alignment of chunk translations in bifocal preview outputs.

Edited bifocal preview output can be read as chunk translation input. So long as there are two spaces 444 separating text and translation chunks, as seen in both FIG. 7 and FIG. 8, the computer program represented in FIG. 5 can still read and understand the contents as chunk translation input, just as it did with the chunk translation input illustrated in FIG. 4. The program simply finds each instance of more than two spaces 444, and then arrays 550 the chunks as specified above.

For example, FIG. 8 shows an edited version of FIG. 7. FIG. 8 best serves as a general depiction of an example in accordance with the present invention, as stated at the beginning of this detailed description of the preferred embodiments. One basic purpose of the present invention is to make it easier to edit chunk translations. “Edit” is intended in the broadest sense, to include minor edits, like spelling corrections or other slight changes, as well as major editing, such as creating, modifying, rechunking, and retranslating entire documents.

A person can easily rearrange the chunks. For example, in FIG. 7, the second line of text 703 has only two chunks. In FIG. 8, the same words have been rechunked into four total chunks. Words that were in separate chunks can be easy included in a same chunk, simply by including no more than one space 333 between them. For example, in the first chunk of the second line of text 703 in FIG. 7 is the word “Para”. In the first chunk of the second line of text 803 in FIG. 8, the words are “Para facilitar”. As is illustrated, editing the chunks is easy.

The program realigns any chunks of text and translation which are unaligned in human edits. When editing a bifocal preview of chunk translation the user need not worry about or make any undue effort to precisely align 666 edited chunks of text and/or translation; as specified above, as long as there are two or more spaces 444 between chunks, the program automatically aligns them.

So bifocal previews can be edited directly. Table aligned chunk translations are able to provide a more readable presentation, including the Bifocal Bitext presentations specified in U.S. Pat. No. 6,438,515, and improvements to such, as specified in the present disclosure. But table aligned chunks cannot be easily and directly edited without customized software. Meanwhile, bifocal previews of the chunk translation in alignment can now be directly edited in many of the most common text editing environments 111.

Table chunk alignment is precise. Non-Latin texts, such as Cyrillic or Mandarin, are not always readily alignable in the bifocal previews, due to different base widths in their respective monospace font renderings. Table chunk alignment effectively resolves this problem, while delivering precise and readable chunk translations in more global multilingual environments.

Table chunk alignment can print in increasingly bifocal outputs. As illustrated in FIG. 18, the text and translation fonts can be manipulated to appear on separate focal planes. This “bifocal” rendering of text has utility defined in U.S. Pat. No. 6,438,515. The claims in U.S. Pat. No. 6,438,515 however do not allow for “study text” and “teach text” to have the same height. Nor do the claimed formatting options allow a weak-styled “translation” to be printed in a color separate from the strong-styled text. Nor is there flexibility with respect to the background color. Thus, within the present disclosure, FIG. 18, FIG. 19 and FIG. 20 show a more effective bifocal presentation where the translation and text appear with the same height; the formatting of the texts is now far more flexible to adapt to variable background contents.

Bifocal output is enhanced when horizontal scale is controlled. Bifocal rendering of chunk translation is enhanced when the weak-style translation 1820 can have the same height 1850 as the strong-style text 1810, but is narrowed in relative horizontal scale; such horizontal scale manipulation can narrow the translation font by a factor of from 33% to 66%; meaning the resulting widths may range from 33% to 66% of the original widths. In FIG. 18, for example, the strong-styled chunk “alinear” 1830 is associated with a weak-styled translation “aligned” 1840; both words have the same number of letters, but the translation chunk appears to be only two thirds as wide as the related text chunk. Meanwhile, the height of both texts is roughly the same 1850. The benefits of such manipulation and narrowing of the translation font while maintaining its height are many: more translation information is available per chunk of text; the translation information is more legible while less apparently visible; a large but narrow translation font allows for a much lighter color density color to transmit the translation information, while at the same time appearing to be less apparently visible. The control of horizontal scale significantly enhances the bifocal utility, since the translation at equal height permits the color to be only slightly different from the background color 1888.

Bifocal rendering can now be achieved when printed against variable background colors. In FIG. 19, the background color 1988 has a medium light gray value. The weak styled translation words 1920 appear to be lighter than the background, while the strong styled text words 1910 are black. In FIG. 20, the background color 2088 has a dark gray value. The weak styled translations words 2020 appear to be darker than the background, while the strong styled text words 2010 are white. Thus, the bifocal rendering can be achieved, even when printing over variable background colors, including images.

One can experience the enhanced bifocal controls described in this disclosure. Note that FIG. 18, FIG. 19 and FIG. 20 are significantly enlarged, in order to illustrate the new bifocal controls. The texts in actual use can be preferably sized normally, such as in 12 pt height. To experience the bifocal effects of the illustration, simply step back to view the illustration from a distance of approximately ten to fifteen feet. Note that the strong-styled text 1810, 1910, 2010 remains easily visible, while the weak styled translation 1820, 1920, 2020 becomes much less visible. This effect is enhanced in lower lighting conditions. Yet as one steps closer to the said Figures, the weak translation becomes more easily perceptible. When printed at a normal scale of 12 pt height, the same effect occurs at normal reading distance. The weak-styled translation 1820, 1920, 2020 does not distract the reader from the strong-styled text 1810, 1910, 2910, yet the weak-styled information is available when the reader refocuses to see it.

So alignment in chunk translation is constant in variable outputs. As stated, the actual alignment can be modified according to user preference. Translations can be aligned above or below the text. Translations can be aligned to the left, right or center. What is constant is each chunk of translation is consistently located and constantly aligned 666 in a regular association with each chunk of text. Thus, a variety of aligned chunk translation formats can be controlled within the various embodiments of the present invention.

From one single text, chunks of translation can vary considerably. Chunks may be full sentences; or large parts thereof; chunks might be single words, two or three words; or any mix or combination thereof. Then, once the text is chunked, translations for each chunk may vary. Translations may be made by humans or machines; translator skill levels may be beginner or expert; translations may be normal or interpretative; popular or ignored; public or private. Translations may be in the same language, a different language, and different languages; when translations are understandable to an intended user, the user can refer to the translation to better understand the chunk of text.

It must be emphasized that chunk translations can be separate from normal translations. Normal translations 230 typically use grammatically correct target language to convey the ideas and intent found in a foreign source text. Normal translations should read and sound normal to a native speaker of the translation language. Chunk translations, on the other hand, need not sound normal. Chunk translations 812 should first capture the intent or the original text, and then where possible illustrate the structure of the original text language. Thus, the chunk translation should be understandable, but it can also illustrate an alternative word order normally used in the original text language. Thus, at times, a chunk translation may read or sound rather unusually structured, or even slightly “poetic”.

Word order may sound weird in chunk translation. For example, in FIG. 8, the translations on the second line of chunk translation 804, if unchunked, would read “to make it easier the comparison between both”. In FIG. 7, the same idea expressed in a less chunked translation 704 does not sound as weird: “In order to make comparison between the two easier.” While the chunk translation may sound odd in the translation language at times, it can more accurately portray the construction of the text language, while still conveying the intent of the text language.

A text can be translated normally; then, in a separate version of translation, “chunk translated”. The text could first be chunked, and then each chunk translated. Or the text can first be normally translated and then later chunked as the translation is chunked. As illustrated in FIG. 2, and FIG. 7, the advantage to translating before chunking is the production of a normal translation, which conveys the overall meaning of the original text. Then, if the text and translation are further chunked and edited, as is illustrated in FIG. 8, the intention of the original text may continue to be conveyed, while the structure of the original text can also be partly illustrated.

The “normal translation” can be chunk translated back to the language of the original text. FIG. 12 shows the normal translation text 220 from FIG. 2, with aligned chunk translations rendered in the language of FIG. 1. In other words, within FIG. 12, the text language is English, while the translation language is Spanish. In other words, FIG. 12 reverses the languages found in FIG. 7. While the languages are reversed, the words are not identical. For example, the last word in the FIG. 1 text 130 is “batalla” which means battle. In FIG. 2, the “batalla” word is translated as “difficulty” 230. In FIG. 12, the chunk translation is not “batalla”; the chunk is translated as “difficulty” 1230. While such differences in these illustrations are subtle, they are material, since they cause the language learner to compare words, which reinforces the knowledge of the words, and their structure.

Chunks of translation can alternate or “weave” in and out of a normal text. FIG. 13 illustrates chunks of translation alternating with chunks of text, printed in an editable bifocal preview. Where alternating chunks of translation now appear to be formatted in strong-styled type, the original language text is alternatingly formatted in weak-styled type. Thus, within a single chunk, the text and translation can be switched. The result is a bilingual text which is aligned 666 with a correspondingly bilingual translation. One advantage in this form of chunk translation presentation is a more gradual introduction of foreign language introduced in context with familiar words in known language.

A chunk “translation” can be in the same language as the original text. FIG. 11 shows chunks of weak-styled “translation” in the same language as the strong-styled original text. In the FIG. 11 example, which is aligned in the bifocal preview format, both the larger text and the smaller interlinear text are in the Spanish language. However, the so-called “translation” words 1120 in the smaller weak-styled text are not the same words as those in the larger strong-styled text 1110. Each chunk of smaller text attempts to say the same thing as the larger text chunk, while using different words. One advantage of this form of chunk “translation” can be, for the language learners, a more complete immersion experience in the language being learned.

The weak-styled “translation” can be in a lesser known language, while the strong-styled text can be in a language well known to the reader. When, in accordance with the present invention, the full height of the narrowed weak-style text allows its color to be very close to the background color, the reader can read the strong-styled text without significant distraction. There may be benefit from unconscious or preconscious exposure to weak-styled and aligned chunks written in the new language. There certainly is conscious benefit from the availability of translated chunks aligned 666 anywhere the reader chooses to refocus to see how the idea can be written in the lesser known language.

Aligned chunk translations help a reader to compare words used in context with other words. The words may be in the same language. The words may be in different languages. The words may “code switch” or mix between languages. What is important is that the words combine to express messages that are both comprehensible and entertaining or meaningful to a reader. When the reader understands and cares about a message, or “what words say”, then a reader is also likely to care about the actual language used to express the message, or “how the words say it”. Comparing words used in meaningful contexts helps a reader to learn language.

But a reader needs to trust that the provided chunk translation word comparisons are accurate. To effectively learn a word or group of words, it must be believed that they actually signify what is claimed. Repetition of the words used in variable contexts ultimately earns the trust of a language learner. However, if chunk translations cannot be trusted to provide accurate information, then they are not useful. Therefore any system to control chunk translations must provide easy error correction, alternative chunking, variable translation and other such instantaneous control of edits. Increasingly accurate translations will be more trusted.

Easily edited chunk translations can easily be made more accurate. Easy error correction and easy creation of alternative versions of chunk translations enables multiple human editors to easily input chunk translation data, which can be stored, sorted and statistically analyzed to inform systems producing automatic machine generated chunk translation. Easy human editing of machine generated chunk translation can inform machine learning and improving quality in automatic production of chunk translation.

Now there is an easier way to edit chunk translations. In accordance with the present invention, chunking a text and/or translation is as simple as adding a space between chunks; both text and translation can be controlled in one single document 111; this document can be controlled within the most simple of text editors, including the standard means of text input widely used on the Internet known as the “Textarea Input” field.

Existing machines can now more easily produce editable aligned chunk translations. Variable algorithms can be used to mechanically select text chunks and translate them with current machine translation systems such as the Google Translate application. Simplified human editing of resulting mechanical chunk translation can inform machine translation systems with both general language usage data for large groups and customized language data for individual learners and translators. Easy human editing can provide useful information to language learning machines.

Humans can now more easily transfer chunk translation knowledge to machines. A human translator can use almost any text editor to quickly produce a chunk translation, which can be consistently aligned in a variety of outputs, in accordance with the various embodiments of the present invention. When the work is shared on the Internet, any errors in chunk translations can easily be corrected, and variable or alternative chunk translations of the same text can also be readily produced. Such increasingly plentiful and accurate data can be used by statistical programs and computing machines to automate the process of chunk translation.

Machines can now acquire data needed to better automate chunk translations for humans. As the disclosed apparatus processes an increasing amount of chunk translation data, machines can learn to produce more useful and specialized chunk translations, including chunk translations customized for individual use cases. As an individual interacts with a chunk translation program, for example, the program can learn what words an individual knows, how the individual uses such words and which language(s) an individual is learning; the program can use such knowledge to select new texts which are appropriate for an individual human language learner.

Humans and machines can both use this system to learn language. Simplified editing, in accordance with the various embodiments of the present invention, enables knowledgeable human translators to correct errors in chunk translations produced by machines or novice translators. Thus, both novice translators and machines can use the present apparatus and method to get more accurate translation information, and thereby learn to produce more accurate chunk translations in the future.

Like machines, humans can also learn language while learning to translate. Apprentice human translators can, where available, employ machine translation and online dictionary services to roughly chunk translate simple texts in a language being learned. As errors are corrected and more informed translation and annotation information is added by more knowledgeable translators, the apprentice translator can learn. Since the apprentice has invested time and is likely to have questions from their translation attempt, new information added by knowledgeable translators can provide the apprentice language learner with meaningful input.

The method and apparatus form a system to serve language learners. Easily aligned and edited chunk translations, in accordance with the preferred embodiments of the present invention, enable quick knowledge transfer between humans and machines. Individual machines can adapt to serve individual humans with specialized sets of language information, especially as individual humans in the process of using the system inform machines as to specifically which chunks the human knows and in general what kind of chunks the human wants to learn.

The system can process human input to improve machine translation output. One purpose of the present system is to provide a means and apparatus to edit, easily, chunks of translation related to chunks of text. One key objective is then to collect edits and other translation data and knowledge, and then refer to this collected knowledge as needed to process automatic or mechanical chunk translation output.

Output of aligned chunk translations can be printed on many display technologies, including print on paper, such as in printed books, booklets, compact disc liner notes, magazines, pamphlets, cards, individual sheets and the like; other display methods may include electronic displays, using television, CRT, LCD, LED, projection and other emerging electronic display technologies, so chunk translations can be accessed with televisions, desktop and laptop computers, tablets, touch screen devices, mobile devices such the iPhone, Android and other cellular phones, gaming devices such as Wii and XBox, public kiosks, digital readers such as the Amazon Kindle, E-ink technologies and a vast plurality of other existing and emerging display technologies.

Input by humans of chunk translation knowledge is simplified. In accordance with the preferred embodiments of the present invention, related chunks of text and translation are simply controlled within a flexible and versatile document type. Where humans are able to input chunk translation data, for example while viewing chunk translations displayed on computer screens, mobile devices or other digital device connected to the Internet, humans can correct errors and/or provide variable translation information input. Humans can thereby transfer knowledge to machines, which can use the knowledge to produce enhanced chunk translation output.

Many pairs of languages can now be chunk translated. Any language that can be digitally written in Unicode and normally separates words with single empty spaces can be chunk translated with any other such language. Large numbers of speakers of such languages are already communicating using the Internet. Many more language users are predicted to arrive in the coming years, as mobile devices such as cellular phones increasingly provide Internet access.

The Internet can provide an increasingly multilingual experience. Useful websites such as Wikipedia.org are already translated into hundreds of languages. The translations are not created by official institutions, but rather by individuals who have Internet access and care about what their words say. As the next, billion language users connect to the Internet, it is likely that more user-generated translations will be used to spread human knowledge. The present system of chunk translation intends to serve in this process.

Foreign texts can be made comprehensible, even for casual students. Even if a user is not an active student of a particular language, a foreign text expression of, for example, a pithy or insightful saying rendered in chunk translation can make the text more comprehensible thus and provide the user with an incidental learning opportunity.

There are immediate practical applications for the chunk translation system. Translation machines can collect useful data from humans who use and improve the chunk translations. Variably skilled humans ranging from professional teachers and translators to absolute beginners can use the system to learn language. Organizations can use chunk translation to help individuals and groups to understand and communicate with more language. Authors and Publishers can chunk translate to add derivative value to existing copyrights. Conversely, individual fair use citations rendered in chunk translation can enhance free commentary, cultural dialog and other benefits for the public.

Digital records of minority languages can be made. Where machines do not have existing corpuses of translations available for statistical production of machine translation, the present method and apparatus provide initial chunk translation data to be collected. Easily edited chunk translations can thus include minority and endangered languages. Those concerned with language extinction can use chunk translations to create and store digital records of written language. Alternatively, minority dialects, even fanciful or personalized forms of speech can be recorded and referred to when producing machine generated automatic chunk translation.

Text transcripts of audio recordings can be chunk translated. For example, recordings of singing and musical performances can be accompanied by the lyrics in chunk translation. Audio recordings may be in standard .MP3 encoded formats or other audio formats. Text transcripts of audio video recordings can also be enriched with accompanying chunk translation. For example, videos on popular video sharing sites such as YouTube can use the various embodiments of the present invention to provide improved services for large populations of language learners.

Aligned chunk translations can be synchronized with video. Thus, a learner can hear the language while reading it, and also gather rich context from associated images. Services such as YouTube allow users to easily pause the video, so they can study more carefully any example of language usage that they wish. Chunk translations can thus be aligned with popular materials widely known in certain language cultures.

Also, close-captioned audio/video programs can be chunk translated and captioned in both text and translation format.

Authentic materials can easily be made more comprehensible for language learners. With chunk translated transcripts to audio and video recordings, learners can study real language as it is used in authentic contexts by well known native speakers and performers. Increasingly easy production and improvement of chunk translated transcripts can result in a high volume of comprehensible and authentic materials, from which select customizations can be made to suit an individual language learner's preference. Thus, a library for Free Voluntary Reading materials can be developed.

Common interests can bond users forming social networks. As users of the system make and use chunk translations, they actively express preferences and interests. A well known performer of lyrical songs, for example, can attract the interest and affection of multiple users of the system. Where such interests and preferences are shared, human bonds such as friendships can be made. Users can gain familiarity and trust with one another. New information of possible interest and utility can be more readily accepted as it can arrive from trusted sources within social networks.

Interesting materials in chunk translation can be discussed. Comments, forums, newsgroups and other such mechanisms to host public dialog can enable Internet users to discuss chunk translations in general and in particular: and resources, contents, contexts or messages can be actively discussed and/or debated, also in chunk translatable text. One purpose of the present method and apparatus is, after all, to help people exchange meaningful input and in so doing to learn each others' language. When people use language to experience and talk about things they care about, language is learned.

More meaningful input can be made available to more language learners. As described earlier, the vital nutrient needed to grow language in human brains is meaningful input. When a language learner both understands and also cares about input that is heard or read, then language is learned. As mentioned, the learner is usually less interested in the words and more interested in the message or context the words impart. As words are repeated in varying and interesting contexts, language is believed, reinforced and learned.

Emerging uses and controls of chunk translation could be plentiful. Most of the previously cited capabilities have been implemented in current prototypes of the present apparatus. As communications technologies continue to advance and evolve, and also with many currently existing technologies, there are many possible future uses and controls for the present chunk translation system.

Interaction between concurrent users can be enhanced. For example, if two users are online at the same time, while coincidentally learning each others' language, systems can be employed to enhance their communication and interaction. Records of the resulting communication could be used to provide or develop further learning material, with respect the specific contents of the communication.

Chunk translations line breaks can be better managed. As outlined in U.S. Pat. No. 6,438,515, when words wrap within horizontal limits of a medium of display, chunks of text and translation can be proportionally broken and resumed on subsequent lines.

A special chunk translating text editor can be implemented. While the present invention can enjoy wide use in a plurality of currently available text editing systems, a specialized chunk translation editor can provide a variety of enhancements, such a variable automatic chunk width levels, automatic chunk translation, better chunk translation word wrapping and line breaks, and similar specialized enhancements.

Editable table chunk alignment of non-monospace text can be useful. As more refined presentations are more directly editable, more corrections and variable translations can be input into the system. Directly editable table chunk alignment is possible with current HTML5/CANVAS technologies.

Timed text can provide chunk translations synchronized with audio. Recordings of sound can be accompanied by animated text and translation timed to coincide with audible events, such as pronunciation of speech. Parallel animation of language parts within specific chunks can provide animated in chunk alignment. Chunk translations may then be synchronized with both audio and video materials, including authentic materials.

Intra-chunk alignment can relate detailed parts of text and translation. Within a single chunk, further alignment can be made to more precisely connect respective language parts. Even within single words, linguistic alignment can be made with syllables, verb conjugations and the like. Such detailed alignment can be achieved with color and style modifications to related parts of the texts, as well as, as suggested in the previous paragraph, with animated text.

Variably chunked text with variable translations can be animated. Where texts have multiple versions of chunk translations between a specific pair of languages, the variations can be animated. Experimentation in such animated presentations may result in preconsciously processable information to assist in brain preparation and other learning processes.

Variable audible pronunciation records of text can be shared. In early stages of reading, it is critically important to hear proper pronunciation of the words. Widely adopted recording and communications technologies and interfaces can enable various users of the system to record multiple versions of pronunciation of a text. Such recording may be sorted and prioritized to result in readily accessible, affective, engaging and entertaining variations of speech to be made available for learners of the language of the text.

Variable audible pronunciation records of chunks can be shared. Similarly, specific words, phrases and chunks of recorded spoken language may be isolated and organized to be easily sorted, prioritized and made available in a commonly shared, group created audible dictionary, in association with chunk translations.

Audio chunk echo effects can be produced and controlled. Chunk translations can also be output audibly, where faint recordings of chunks of known language could lead or follow louder recordings of possibly unknown chunks. Users could control this chunk echo effect according to preference, perhaps in introductory, slow-paced vocal renderings of a text. Chunked text and translation can be machine-recognized and sequentially converted to speech in the corresponding languages and at different volumes to facilitate language learning.

Images can be associated with chunk translations. Related chunks of language can also be related to visual images, including videos, motion pictures, scenes from movies and music videos, still pictures, photographs, illustrations, paintings, sculpture, artworks, details of such, and the like.

Emotions can be associated with chunks. Recorded segments of musical expression, or emotive expressions of human voice such as laughter or crying can be associated with chunks. Emoticons, or graphically rendered iconic facial and other expressions can be associated with chunk translations. Where there is real emotional connection to any chunk of language, the learning happens faster and is recorded more deeply in the consciousness.

Color meanings can be controlled. Parts of language rendered in text can be associated with colors representing grammatical functions, such as nouns and verbs. Alternatively, color may be used to represent meaning categorized experimentally, as in “what question does the bit of language answer” or “does this bit provide more information about ‘what’ is being discussed or ‘who’ says so?” Users could experiment with color used to add meaning to text, and then form group opinions as to the efficacy of one method or another. Individuals could avoid the color conversation altogether.

Rating systems can be implemented to identify potentially meaningful input. To sort and prioritize variable versions of a text rendered in chunk translation, interactive systems to qualify instances of chunk translation may improve a user's ability to access higher quality information faster. Ratings could apply to translation accuracy, recording audibility, status of community member, individual status, group status and other such quantifiable and communicable measures of information and provider quality.

Chunk translating can be made into a game. Explicit rewards can include collectible symbols of status which members of a community can use to compare and evaluate other members of the community; such symbols may include first to translate a chunk, most popular translation of a chunk, best image associated with a chunk, best audio and/or video, best explanation, best pronunciation, and the like. Ownership of chunks could be vulnerable to theft by players who want the chunk more.

Language can be personalized and made individually meaningful. The system may be used by individuals to develop individual dictionaries. Complete with select digitally recorded audio and visual associations linked to personally meaningful chunks of language, individual dictionaries can be maintained by individual users and shared with other individuals. Users can compare and contrast personalized interpretations of commonly understood and meaningful chunks of language.

Chunk translations can be added to a text only where needed by an individual user. The system described learns to connect associated chunks of language; it could learn much if not all of the language an individual knows, and then, within a new text, provide chunk translations only where the individual needs them.

Language identity can be classified by a user. Whether a person is part of a group, or even as an individual, words in a person's personal lexicon can be classified and sorted by the user before it is classified and sorted by the traditional language name. Individual or smaller group interpretation of any chunk of language could be differentiated from a larger group opinion, to thus enable precise customization of language information for an individual user.

One world dictionary can be shared. Where in the past, languages were sorted by name and dialect, a future single lexicon may contain all words definable in chunk translation. Thus, any apt phrase useful in one language could more readily be adopted for use in another.

Robust text string differentiation interfaces can be developed. Single words or text strings often have multiple meanings within a single language. The same text string may also lead to multiple meanings within multiple languages. The same text string may have multiple user differentiations between multiple definitions in multiple languages. All of these related meanings and definitions can be organized under one single shared text string or “word”. While potentially large, the associated information would be finite, and could be controlled in a simple interface able to manage and sort differentiations in definition. Thus, “lookup” of any text string could provide rich results and even opportunities for dialog, which can be made comprehensible and meaningful as chunk translations are deployed.

Group opinions of shared meaning can be formed. By sorting and prioritizing individual and personalized interpretations of meaningful chunks of language, groups can form opinions. Urbandictionary.com is a model example of this process. Enriching this model with sortable digital records of associated audio and visual resources can provide a rich, authentic and effective language learning resource and interface.

Minority opinions of shared meaning can be enjoyed. While larger groups may form dominant opinions, minority opinions can still be accessible. For example, the text string “war on terror” could be commonly understood by a majority of English speakers to mean a “preemptive defense against dark foreign fanatics”; a minority interpretation of the same phrase could be an “Orwellian misdirection used to help whites secure power in the form of energy resources”. While neither opinion would be absolutely factually correct in the Wikipedia sense, both groups of public opinion could be made available and debated from and within one world dictionary of chunk translation.

Chunk translations can be customized for individuals. The system and machine may grow to know what language an individual human knows and what language the human wants to learn; the system could then predict what chunks of language the human is ready to learn and then provide personalized chunks translations aligned with new chunks of language to be learned.

While potential future uses may vary, aligned chunk translations are useful now. In accordance with the preferred embodiments of the present invention, language learners can now easily compare chunks of text with chunks of translations constantly aligned in versatile print formats. Additionally, chunking text and relating translations is now simply achieved by adding an extra space between relatable words. Edit control of all the text and translation is now provided in a single document. Almost any text editing program can now be used to make and improve chunk translations. Variable versions can now readily be shared online. Chunk translated transcripts now can accompany sound and video recordings of authentic culture, to provide more comprehensible and meaningful input for language learners. Humans and machines can now use the chunk translation system to learn. In accordance with the present method and apparatus, simple and versatile edit control can help human transfer chunk translation knowledge to machines. Machines can in turn produce more accurate chunk translations for language learning humans. The system in accordance with in the present invention can be, used to produce language learning.

In conclusion, what is described here is a system and method to make authentic texts more comprehensible to language learners; to compare and relate words used in meaningful contexts, to define chunks of text with related chunks of translation; to constantly align the related chunks in a variety of print formats; to more easily process bifocal alignments described in U.S. Pat. No. 6,438,515; to easily edit, correct errors, regroup chunks and share variable translations; to separate and relate chunks simply by adding extra spaces between them; to control both text and translation chunks within a single document; to control the documents in almost any text edition program; to share chunk translation knowledge with language learners on the Internet; to produce useful data and statistics for machine translation; to improve automatic production of chunks translations; and to align chunk translations for language learners.

In simple terms of chunks, a method and apparatus are disclosed to order translations with a text, so readers can learn to associate words they already know with new words that they are learning. The method and apparatus helps readers and translators to group, segment or “chunk” a text into single words or groups of words, and then to translate each “chunk” into known language; the resulting “chunk translation” provides known text in orderly association with unknown text, thereby helping a reader to understand any new “chunks” of language. The method and apparatus allow users to variably “rechunk” and retranslate the chunks, in the same language, similar dialects or separate languages; versions of these variable chunk translations can easily be updated and traded on the Internet, in a plurality of widely used programs, and printed on paper or displayed on electronic displays, so people can easily use these “chunk translations” to learn new language.

The present invention may also have future uses. While the invention has been disclosed in connection with preferred embodiments, it is not intended to be limited to the specific embodiments set forth above. For example, although the preferred embodiment of the present invention enables a user to access the computer program via the global computer network, or Internet, other versions can be adapted to function within a single computer. Or, for another example, language learners may find utility by including foreign language chunk translations in between the lines of text consumed in the native language. In another example, the invention could be used by non-language learners for a separate purpose, such as using known language to comment on other known language where it is used. Accordingly, the present invention is intended to include such alternative embodiments and equivalents as may fall within the scope of the claims set forth below.

What is claimed is:

1. A text aligning system for placing segments of reference text in alignment with corresponding segments of foreign text, to facilitate learning of foreign language, the system comprising:
a computer text editing environment which, within a single text input area, enables control of text in one or more human languages, while also allowing inclusion of more than one space between words;
a foreign text which is segmented into chunks of single words and/or phrases of multiple words, where the foreign text is comprised of language that may be unknown to a person learning the language of the foreign text;
a reference text which is known to the language learning person, where the reference text is segmented into chunks of words or phrases, and where each segmented chunk of reference text corresponds to an associated chunk of the segmented foreign text;
a single combined source text containing both the segmented foreign text along with the correspondingly segmented reference text;
a computer program which can read the combined source text input and then align printed or displayed output of corresponding foreign and reference text segments, so that the corresponding segments are consistently aligned across a plurality of display formats, including directly editable formats;
a database in both the foreign and reference text languages, which provides segmentable, editable, correctable and improvable combined source text, thus providing increasingly reliable segmentation and segments of aligned reference text;
whereby a person who is learning to read a new language can access segments of reliable reference text in consistent and precise alignment with segments of the foreign text, and thereby learn new language within the foreign text.

2. The system as defined in claim 1 wherein the segmentation within both the foreign text and the reference text is achieved and executed by adding at least one extra space between text segments, so that each distinct separate segment of text is separated by at least two or more spaces.

3. The system as defined in claim 1 where both the foreign text and the reference text each have an equal number of corresponding text segments, so that each specific segment of reference text may be consistently aligned with its corresponding segment of foreign text.

4. The system as defined in claim 1, where within the single combined source text, each line of segmented reference text is located either on the line directly above or upon the line directly below the line of segmented foreign text.

5. The system as defined in claim 4, where each paragraph of segmented foreign text is contained on one single unwrapped line of the combined source text, and then each corresponding paragraph of segmented reference text is contained on a separate line of said source text, located either upon the line directly above or upon the line directly below the foreign text.

6. The system as defined in claim 1, where a title and translated title are included and managed within the contents of the single combined source text.

7. The system as defined in claim 1, where additional metadata selected from among one or more of the categories of author, performer, translator, country of origin, content filters, commentary, learner level, tags and hyperlinking is included and managed with the contents of the combined source text.

8. The system as defined in claim 1, where both the foreign text and reference text are readily segmented, resegmented, edited, corrected and improved, within a single combined source text, which can be controlled within the computer text editing environment.

9. the system as defined in claim 8, where the single combined source text can be managed within single Input forms commonly used on the Internet.

10. The system as defined in claim 1, where the combined source text is stored in computer memory, so that a program can find the corresponding segments of foreign and reference texts, and then output them in consistent alignment across a plurality of display formats, including printed paper of various sizes, internet web pages, computer displays, cell phone displays, tablet computer displays, television monitors, game system display screens, and projectors.

11. The system as defined in claim 10, where the segments of foreign and reference texts are aligned in basic unformatted fixed font monospace text, with spacing managed to insure a consistent minimum of two or more spaces between the aligned segments of the texts.

12. The system as defined in claim 10, where the segments of foreign and reference texts are aligned in rich text format monospace text, with spacing managed to insure alignment of larger font sized foreign text aligned with smaller font sized reference text.

13. The system as defined in claim 10, where the segments of foreign and reference texts are aligned in table formats, to enable precise alignment of variably styled foreign and reference texts.

14. The system as defined in claim 5, where combined foreign text and reference text lines can together wrap as a single cohesive unit, maintaining continuity with reference text ordered consistently above or below the foreign text, when wrapping to the subsequent line.

15. The system as defined in claim 14, where the program inserts coordinated line breaks or new table rows to enable cohesive wrapping of the combined foreign and reference texts to adapt to variable limited horizontal widths of display space.

16. The system as defined in claim 13, where the table formatted contents of variably sized foreign and reference texts are directly editable by a language learner using the computer program, to readily modify the segmentations and contents of both the foreign and reference texts.

17. The system as defined in claim 10, where the texts are formatted bifocally, wherein the texts the foreign text is strongly formatted to remain readily visible in comparison to weakly formatted reference text, and wherein the weakly formatted reference text becomes less visible when the level of illumination decreases.

18. The system as defined in claim 17, where the foreign and reference texts are of similar height, but horizontal scaling of the reference text is approximately one quarter to three quarters of the width in comparison to the horizontal scaling of the foreign text.

19. The system as defined in claim 17, where the foreign text is printed or displayed in a color that is in 100% contrast relative to a background color, and is thus easily read when viewed in a range of levels of illumination, while the aligned reference text is printed in a color that is in 5% to 50% contrast relative to the background color, thus becoming less visible and less distinguishable from the background color when viewed in lower levels of illumination in the range.

20. The system as defined in claim 10, where the aligned foreign and reference texts are timed to be synchronized with video or audio visual media.

21. The system as defined in claim 8, further comprising a customized program which accepts segmented input pasted in from other programs and can be controlled by a user to print or display the input in variably aligned outputs, including directly editable outputs.

22. The system as defined in claim 21, where the user can select and control the languages of the aligned foreign and reference texts.

23. The system as defined in claim 22, where the user can select the same language for both the foreign and reference texts.

24. The system as defined in claim 22, where the user can reverse the languages of the foreign and reference texts; to thus align lesser known segments of text faintly formatted between the lines of highly visible known text.

25. The system as defined in claim 22, where the user can weave the reference and foreign texts, so that the language segments switch between both languages.

26. The system as defined in claim 8, where the edited and improved contents can be saved in a database or within computer memory.

27. The system as defined in claim 8, where both segmented translations and unsegmented translations can be managed and saved within a database or computer memory.

28. The system as defined in claim 26, where automated machine translation systems can access and modify the saved segmentation and translation data, to thus produce more accurate translations.

29. The system as defined in claim 26, where an individual user's language database can be saved separately from a group language database, to enable segmented translations to be customized for the individual user.

30. The system as defined in claim 8, where the program accesses the single source text in memory stored within a single computer, and is thus able to format segmented reference text aligned with segmented foreign text while not having a computer network connection.

31. The system as defined in claim 8, where the program accesses the single source text in memory stored on a computer network, then aligns the text segments in variable print or display environments.

32. The system as defined in claim 31, wherein the computer network is the Internet.
